(19) United States
(12) Patent Application Publication
(10) Pub. No.: US 2024/0218002 A1
(43) Pub. Date: Jul. 4, 2024

(54) PHOSPHINE-UREA LIGANDS FOR TRANSITION METAL CATALYZED CROSS-COUPLING REACTIONS

(71) Applicant: The Texas A&M University System, College Station, TX (US)

(72) Inventors: Levi T. Litwiller, College Station, TX (US); Andy A. Thomas, College Station, TX (US); Lupita Sarahi Aguirre, College Station, TX (US); Hai T. Ly, College Station, TX (US)

(73) Assignee: The Texas A&M University System, College Station, TX (US)

(21) Appl. No.: 18/535,150

(22) Filed: Dec. 11, 2023

Related U.S. Application Data
(60) Provisional application No. 63/386,756, filed on Dec. 9, 2022.

(51) Int. Cl. C07F 9/6584; B01J 31/22; B01J 31/24; C07F 9/6506

(52) U.S. Cl. CPC C07F 9/6584; B01J 31/2291; B01J 31/2447; B01J 31/2466; C07F 9/65068; B01J 2231/4238; B01J 2531/004; B01J 2531/824

(57) ABSTRACT

Carbon-carbon bond forming reactions are the cornerstone of organic chemistry. A new class of ligands was developed for transition metal catalyzed cross-coupling reactions. These phosphine-urea ligands incorporate a urea subunit into the backbone of the ligand, which is designed to bind to the organometallic coupling partner and simultaneously facilitate and direct transmetalation of the nucleophile. Synthetic routes were designed and executed to synthesize phosphine-urea ligands. These ligands catalyze a wide variety of cross-coupling reactions including Suzuki, Negishi, and Buchwald-Hartwig cross-couplings. Aryl-aryl, alkyl-aryl, and alkyl-alkyl C—C cross-couplings are performed successfully with these ligands. In addition, specific chiral phosphine-urea ligands catalyze Negishi cross-couplings enantioselectively from a racemic alkylzinc nucleophile.

### RELATED APPLICATION

The present disclosure claims priority to U.S. Provisional Patent Application Ser. No. 63/386,756, filed Dec. 9, 2022, which is incorporated by reference herein in its entirety.

### FIELD OF DISCLOSURE

The invention generally relates to the field of organic chemistry and specifically to novel phosphine-urea ligands used for the transition-metal catalyzed cross-coupling reactions.

### BACKGROUND

Metal-catalyzed cross-coupling reactions have revolutionized organic synthesis. The most popular of these, the Suzuki-Miyaura cross-coupling, is now one of the most commonly used C—C bond forming reactions in the pharmaceutical industry despite its relatively recent discovery. The widespread use of Suzuki-Miyaura cross-couplings has led to a strong bias towards flat, aromatic small-molecule drugs in today's market, despite the fact that drugs with more sp³-carbon atoms are believed to have greater solubility, selectivity, and potency than primarily sp²-hybridized molecules. The drive to produce complex, pharmaceutically relevant compounds with more tetrahedral carbon atoms has inspired the development of new alkyl-aryl and alkyl-alkyl cross-coupling reactions. However, two primary challenges exist that have impeded the extension of cross-coupling methods to alkyl nucleophiles and electrophiles: facile unwanted β-hydride elimination of alkylmetal complexes, and controlling the cross-coupling product's stercochemistry.

Solving the β-hydride elimination problem requires a discussion of the cross-coupling catalytic cycle (FIG. 1A). The desired pathway for cross-coupling reactions begins at Pd⁰ complex A1, followed by oxidative addition into a carbon-halide bond to give Pd^{II} complex A2. Complex A2 undergoes transmetalation with an organometallic reagent to give Pd^{II} complex A3, which can reductively eliminate the cross-coupling product and return the catalyst to its initial state at Pd⁰ complex A1. However, if the electrophile is sp³-hybridized and contains β-hydrogens, complex A2 can also undergo B-hydride elimination to give π-complex A4, resulting in the formation of unwanted alkene byproducts. As transmetalation and B-hydride elimination both occur from complex A2, the two pathways are ultimately in competition with one another, with the kinetically faster pathway leading to the major product. If transmetalation is sufficiently faster than β-hydride elimination, the latter reaction will occur to a lesser extent. Therefore, one method of suppressing β-hydride elimination is to increase the rate of transmetalation.

The choice of organometallic reagent has a large effect on the rate of transmetalation due to the differences in polarity of the carbon-metal (C-M) bond (FIG. 1B). Higher polarity C-M bonds result in faster rates of transmetalation due to the increased nucleophilicity at carbon. In a direct comparison of the most common cross-coupling methods, Suzuki-Miyaura cross-couplings (metal=boron) exhibit one of the slowest transmetalation rates because of the low polarity of the carbon-boron bond. Grignards and alkyllithiums, on the other hand, transmetalate much more quickly because of the low electronegativities of lithium and magnesium, making the C-M bonds highly polarized. Even so, these organometallics are less desirable for cross-coupling reactions due to their poor functional group compatibility. Between alkylborons and Grignard reagents lie alkylzincs, which are more nucleophilic than alkylborons and maintain greater functional group tolerance than Grignards and alkyllithiums. For these reasons, the Negishi cross-coupling reaction shows great promise for alkyl-alkyl bond formation.

The use of alkylzines does however present a stereochemical challenge. While reliable methods to prepare optically active alkylborons exist, methods to prepare enantiopure secondary alkylzinc compounds are few and limited in scope (FIG. 1C). Methods by Knochel and Beak allow for the preparation of chiral organolithiums which can be transmetalated to zinc stereospecifically to yield enriched alkylzincs; however, using these methods, the scope of nucleophile is necessarily limited to only those that are compatible with alkyllithiums. Stereospecific boron-zinc exchange is another viable method to produce enriched organozincs, but enantiopure alkylboranes are typically produced by asymmetric hydroboration, a method which is incompatible with ketones, aldehydes, and nitriles, again limiting the scope of possible organometallic coupling partners. The most common method of preparing alkylzinc compounds, zinc insertion into a carbon-halide bond, is a radical process which ablates the stereochemistry of the organohalide, so this method cannot be used to make enantiopure alkylzincs. Furthermore, enantiopure secondary alkylzinc reagents are known to racemize under certain reaction conditions, which inhibits their use in stereoretentive cross-coupling reactions. A strategy to circumvent this challenge altogether is to perform a catalytic enantioselective Negishi cross-coupling from a racemic alkylzinc substrate, negating the need to prepare optically active alkylzincs.

The present invention includes novel phosphine-urea ligands that can be used in metal-catalyzed cross-couplings reactions, such as the Negishi reaction, to overcome inherent challenges in these C—C bond forming processes.

To date, there have been five reported examples in the literature of enantioselective metal-catalyzed cross-coupling reactions from racemic alkylzinc nucleophiles (FIG. 2). It is noteworthy that each of these reactions contain a strong Lewis-basic functionality as part of the ligand, the organometallic substrate, or as an additive. Kumada first discovered a chiral dimethylamino-ferrocenylphosphine ligand that could enantioselectively cross-couple racemic benzylic Grignard reagents with vinyl bromide, which was later used to enantioselectively cross-couple an analogous alkylzinc reagent under similar conditions (FIG. 2A). The researchers screened a series of chiral phosphinoferrocene ligands and found that the dimethylamino group was imperative to achieving high enantioselectivity in these reactions. They argue that the nitrogen atom may coordinate with the metal atom of the alkylmetal species, directing its approach toward the transition metal. Hayashi and Ito later discovered that a similar C2-symmetric chiral (bis-dimethylamino)bisphosphinoferrocene also effectively cross-coupled racemic benzylic alkylzincs enantioselectively (FIG. 2B), which may occur through the same mechanism.

Fu and coworkers have also discovered three instances of the enantioselective cross-coupling of racemic alkylzincs. Each report is limited to a single class of alkylzinc substrates. Two of these feature organozincs that contain an amide group which can coordinate to the zinc atom in a five-membered ring (FIG. 2C, D). These substrates, racemic a-zincated N-Boc-pyrrolidine (FIG. 2C) and racemic β-zincated alkylamides (FIG. 2D), were both cross-coupled with their respective secondary alkyl coupling partners in high yields and enantioselectivities. In August 2022, the Fu group also reported the enantioselective cross-coupling of racemic secondary a-zincated amides (FIG. 2E). This reaction is performed with a basic triamine additive which the researchers state likely coordinates to the zinc reagent and improves the transmetalation rate.

Furthermore, many alkyl-alkyl Negishi cross-coupling methods, enantioselective or otherwise, are enhanced by the use of polar cosolvents such as DMI, NMP, DMA, or NMI, and stoichiometric halide additives such as LiCl or LiBr. Once thought to be innocent spectators, these polar cosolvent additives have more recently been found to have numerous impacts on the outcomes of Negishi cross-coupling reactions. The roles that these additives play is still not fully understood, but studies have suggested that one effect of polar solvents and halide salts is nucleophilic activation of the organozinc reagent to facilitate transmetalation of the nucleophile. Studies by Organ, Lei, Oshima, Koszinowski, and Blum strongly suggest that suitable nucleophiles alter the aggregation states of organozinc reagents in solution, forming coordinatively saturated zincate species which are able to undergo transmetalation (FIG. 3).

All of the subject matter discussed in the Background is not necessarily prior art and should not be assumed to be prior art merely as a result of its discussion in the Background section. Along these lines, any recognition of problems in the prior art discussed in the Background or associated with such subject matter should not be treated as prior art unless expressly stated to be prior art. Instead, the discussion of any subject matter in the Background should be treated as part of the inventor's approach to the particular problem, which in and of itself, may also be inventive.

### SUMMARY

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

The present invention relates to a new strategy for enantioselective Negishi cross-coupling reactions hinging on the design of a new class of chiral phosphine-urea ligands which combine the functionality of phosphine ligands and polar cosolvents. These ligands are designed to take full advantage of the previously discussed principles of alkylzinc nucleophilic activation. Transmetalation rates of alkylzinc reagents may be enhanced by coordination of Lewis-bases, and the transmetalation step is typically where the product's stereochemistry is determined. Novel ligands of the present invention can enact enantioselective Negishi cross-couplings using a chiral Lewis base which is designed to coordinate and activate the alkylzinc reagent (FIG. 4). Rather than add a chiral Lewis base as a separate additive, a Lewis-basic urea group is embedded within a phosphine ligand to create a ligand with two functions. First, the ligand itself proposes to activate the alkylzinc reagent, and facilitate transmetalation. Second, there may be a ‘docking effect’ between the ligand and organometallic reagent, wherein the alkylzinc is directed to the transition metal in a highly controlled manner. In this way, the organometallic reagent may coordinate with the catalyst in situ, forming a diastereomeric complex that favors one enantiomer of the desired product.

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary, to employ concepts of the various patents, applications and publications as identified herein to provide yet further embodiments. Other features, objects and advantages will be apparent from the description, the drawings, and the claims.

### BRIEF DESCRIPTION OF THE DRAWINGS

The disclosure may be understood by reference to the following description taken in conjunction with the accompanying drawings, in which:

FIG. 1 schematically shows (A) cross-coupling catalytic cycle, (B) Differences between alkylborons and alkylzincs in cross-coupling reactions, (C) Preparation of enantiopure secondary organometallics;

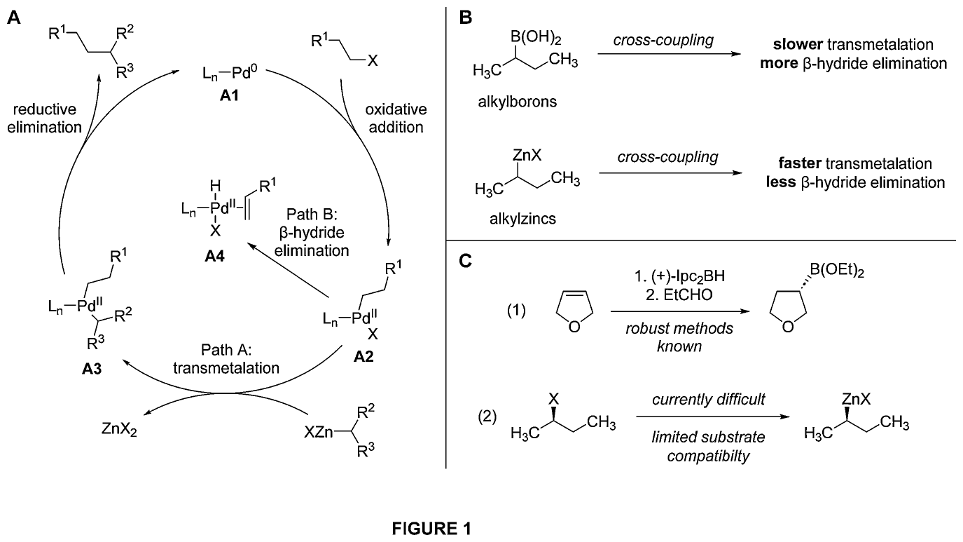

FIG. 2 schematically shows enantioselective Negishi cross-couplings of racemic organozincs (Lewis-basic activating groups highlighted);

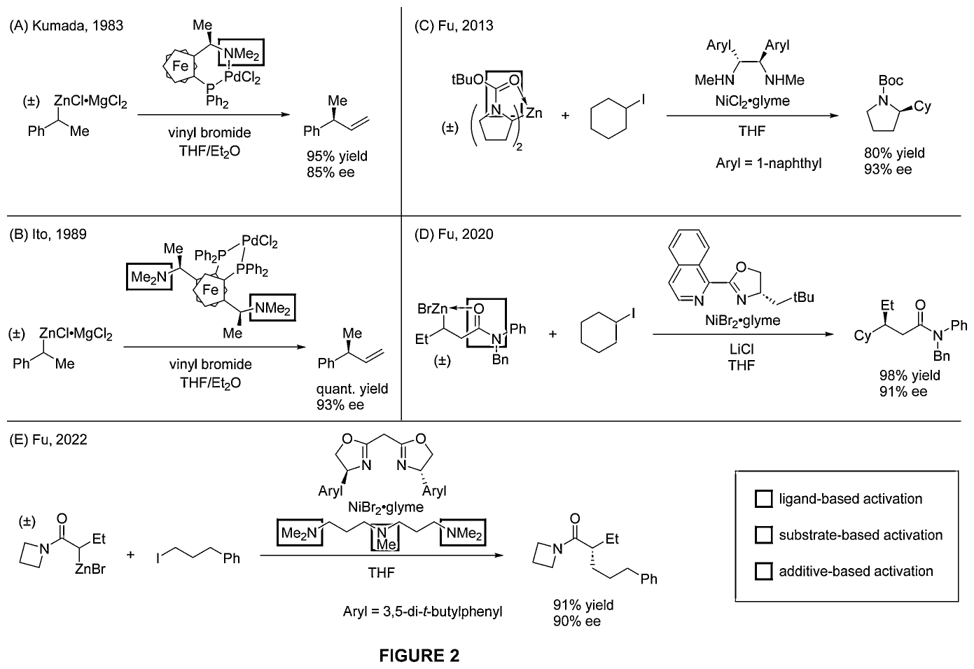

FIG. 3 schematically shows cross-coupling of activated vs. unactivated alkylzincs;

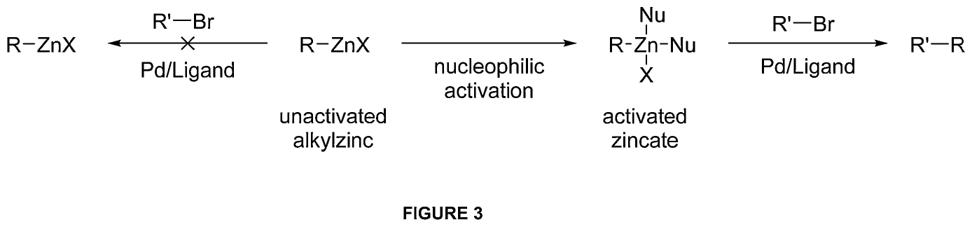

FIG. 4 schematically shows (A) ligand design for combining a phosphine ligand and Lewis-base into one compound and (B) enantioselective cross-coupling of secondary alkylzinc reagents;

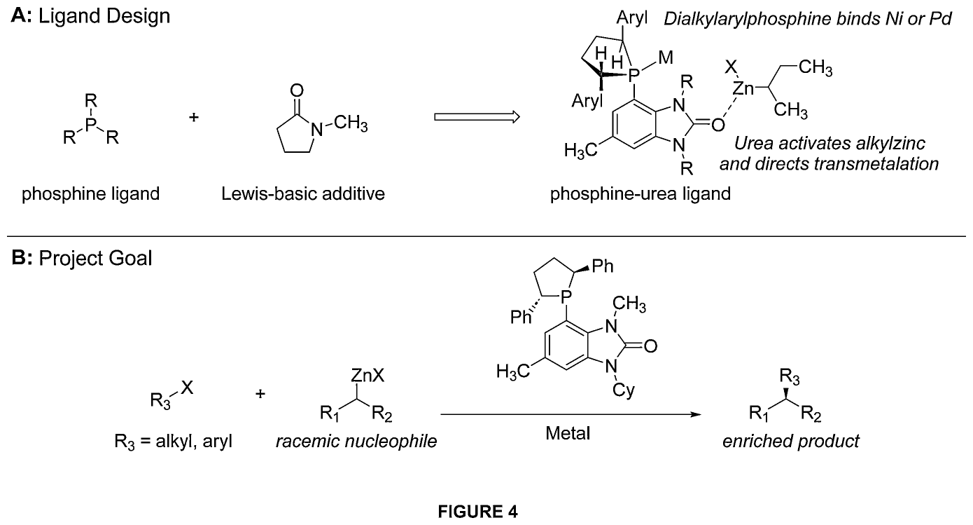

FIG. 5 schematically shows synthesis of phosphine-urea ligands L1 and L2;

FIG. 6 schematically shows synthesis of chiral phosphine-urea ligand L3;

FIG. 7 schematically shows synthesis of chiral phosphine-urea ligand (S,S)-L4;

FIG. 8 schematically shows cross-coupling reactions with ligand L1;

FIG. 9 schematically shows cross-coupling reactions with chiral ligands L3 and L4;

FIG. 10 schematically shows cross-coupling reaction comparing phosphine-urea ligand L4 with commercially available chiral phosphine ligand and (B) commercially available chiral phosphine ligand;

FIG. 11 schematically shows (A) synthesis of (S,S)-L10 and (B) cross-coupling reaction comparing L4 and L10;

FIG. 12 schematically shows the structure of S1;

FIG. 13 schematically shows the structure of S2;

FIG. 14 schematically shows the synthesis reaction for and structure of 1-methoxy-2,5-diphenylphospholane 1-oxide S3;

FIG. 15 schematically shows the structure of 2,5-Diphenyl-1-oxo-1-chlorophospholane S4; and

FIG. 16 schematically shows the synthesis reaction for and structure of chromane S6.

### DETAILED DESCRIPTION

Various illustrative embodiments of the disclosure are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

The text herein uses abbreviations for the following:
“2-MeTHF” means 2-methyltetrahydrofuran;
“b:l” means branched-to-linear ratio;
“Cy” means cyclohexyl;
“dba” means dibenzylideneacetone;
“DCM” means dichloromethane;
“DIBAL” means diisobutylaluminum hydride;
“DMA” means dimethylacetamide;
“DME” means dimethoxyethane;
“DMF” means N,N-dimethylformamide;
“DMI” means 1,3-dimethyl-2-imidazolidinone;
“d.r.” means diastereomeric ratio;
“e.r.” means enantiomeric ratio;
“Et₂O” means diethyl ether;
“EtOAc” means ethyl acetate;
“EtOH” means ethanol;
“FID” means flame ionization detector;
“GC” means gas chromatography;
“IPA” means 2-propanol;
“L:Pd” means ligand: palladium ratio;
“MeOH” means methanol;
“MS” means mass spectrometry;
“NMP” means “N-methyl-2-pyrrolidone;
“NMI” means “1-metylimidazole;
“Ph” means phenyl;
“sBuLi” means sec-butyllithium;
“BuLi” means tert-butyllithium; and
“THF” means tetrahydrofuran.

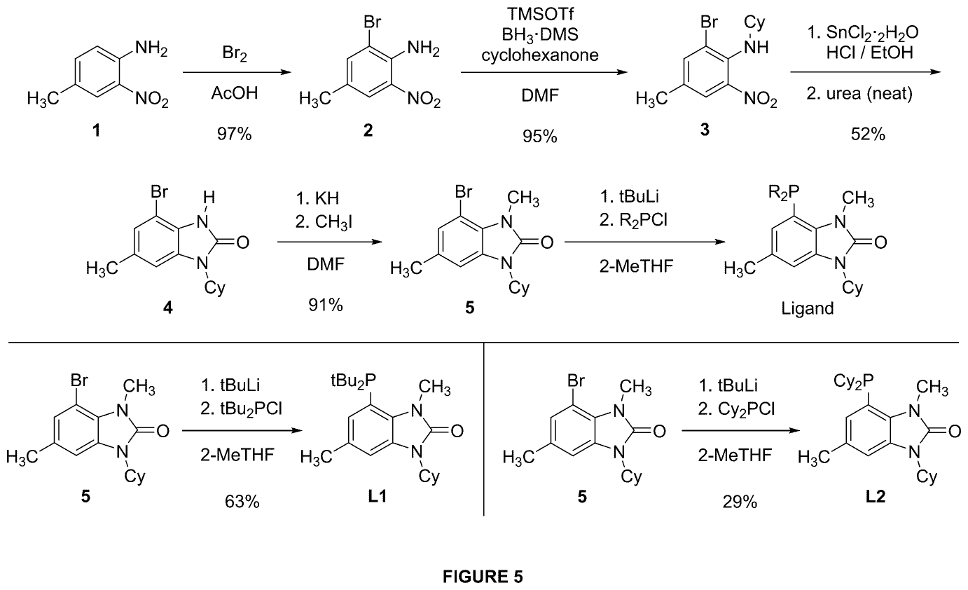

FIG. 5 shows the synthetic process for novel phosphine-urea ligands L1 and L2. The synthesis steps are identical until the final step where different dialkyl phosphines are added. This synthesis process enables 5 to be made on a large scale and enables a diverse library of ligands with different steric properties to be rapidly synthesized by coupling 5 with various R2P—X compounds.

As shown in FIG. 5, the synthesis begins with bromination of 1 with elemental bromine, followed by reductive amination of 2 with cyclohexanone to yield compound 3. This amination was difficult due to the low nucleophilicity of aniline 2 but was made possible using trimethylsilyl trifluoromethanesulfonate (TMSOTf) to activate the ketone and remove water generated by the imine condensation. The nitro group of compound 3 was reduced to the aniline with tin(II) chloride. Hydrogenation with palladium on carbon was attempted for this transformation, but the halogen was also reduced under those conditions. The resulting crude diamine was cyclized in neat liquid urea, and compound 4 was methylated with methyl iodide to give compound 5. Finally, L1 was synthesized by lithium halogen exchange of 5, followed by trapping of the aryllithium species with tBu₂PCI or Cy₂PCI to yield the air-stable phosphine-urea ligands L1 and L2, respectively. The final synthetic reaction step should be performed in 2-methyltetrahydrofuran because when the lithium-halogen exchange of 5 is performed in tetrahydrofuran (THF) or diethyl ether (Et₂O) at −78° C., the solution immediately freezes.

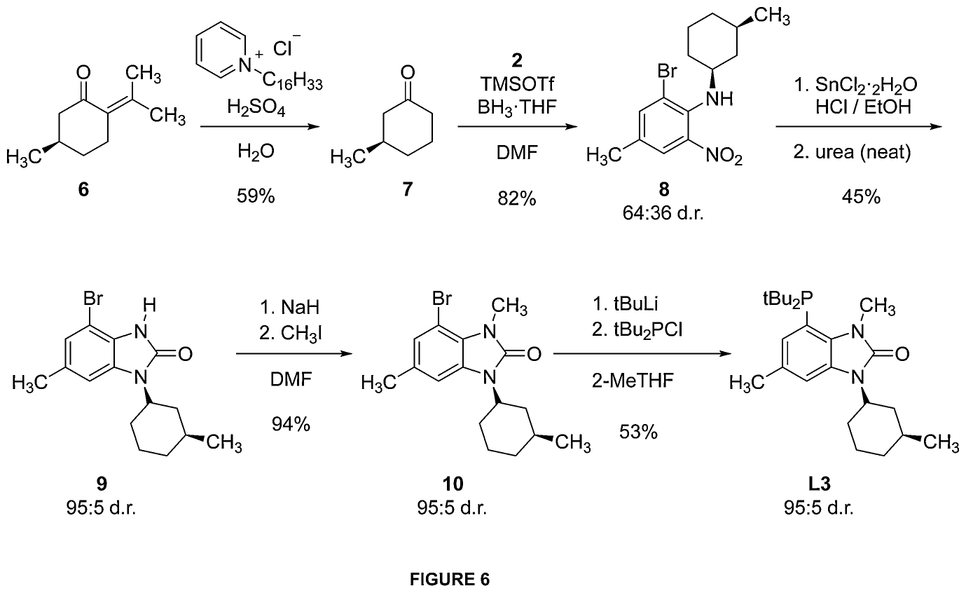

Chiral phosphine-urea ligands were also synthesized (FIG. 6). Ligand L3, an analog of L1 where the cyclohexyl group is replaced with an enantioenriched methylcyclohexyl group, was synthesized following a similar route as described above and shown in FIG. 5. Specifically, as illustrated in FIG. 6, (R)-3-methylcyclohexanone 7 was prepared via retro-aldol reaction from commercially available (R)-pulegone 6 following a reported procedure. Reductive amination of (R)-3-methylcyclohexanone 7 with 2 gave compound 8 with a diastereomeric ratio of 64:36. These diastercomers could not be separated, but the diastereomeric ratio improved as the rest of the synthesis was carried out. Compound 8 was reduced and cyclized to give 9, which was methylated to give 10 in a d.r. of 95:5, from which ligand L3 was synthesized (FIG. 6).

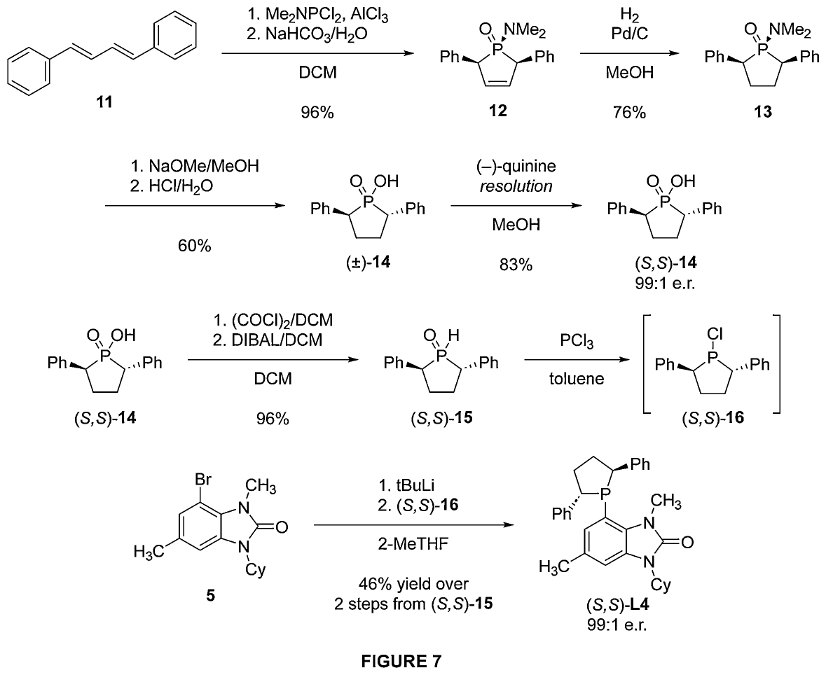

Ligand L4 is designed to be a chiral ligand with stereocenters in closer proximity to the transition metal binding site. FIG. 7 shows the synthesis process for L4. (S,S)-16 may be synthesized with high optical purity using published procedures known to those of skill in the art, such as those of Fox 2008 (Fox, M. E.; Jackson, M.; Lennon, I. C.; Klosin, J.; Abboud, K. A., Bis-(2,5-diphenylphospholanes) with sp² Carbon Linkers: Synthesis and Application in Asymmetric Hydrogenation. J. Org. Chem. 2008, 73, 775-784) and Guillen 2002 (Guillen, F.; Rivard, M.; Toffano, M.; Legros, J.-Y.; Daran, J.-C.; Fiaud, J.-C., Synthesis and first applications of a new family of chiral monophosphine ligand: 2,5-diphenylphosphospholanes. Tetrahedron 2002, 58, 5895-5904), which are herein incorporated by reference.

Diphenylbutadiene 11 may be cyclized with dimethylaminophosphorus dichloride (Me₂NPCI) in a [4+1]-cycloaddition reaction to give phospholene 12, which may be hydrogenated at atmospheric pressure to produce phospholane 13. In a one-pot reaction, the cis-phenyls of 13 may be isomerized to trans-phenyls with sodium methoxide, and the P—N bond may be hydrolyzed with HCl to give the racemic phosphinic acid 14. Using (−)-quinine, 14 may be readily resolved into pure (R,R) and (S,S) enantiomers. Enantiopure (S,S)-14 may be chlorinated with oxalyl chloride and subsequently reduced with DIBAL to give (S,S)-15. Finally, (S,S)-15 may be converted to the chlorophospholane (S,S)-16, which may immediately be used to synthesize chiral phosphine-urca ligand (S,S)-L4 in 99:1 e.r. (FIG. 7). The same steps were taken to synthesize (R,R)-L4 from (R,R)-14.

### Metal-Catalyzed Cross-Coupling Reactions

To obtain a broad scope of the catalytic activity of phosphine-urea ligands, a variety of different cross-coupling reactions were tested including C—C, C—N, and C—O bond forming transformations with both palladium and nickel catalysts. While attempts at C-O cross-couplings were unsuccessful, these studies showed that these novel phosphine-urea ligands can catalyze aryl C—N bond formation, as well as sp²-sp², sp²-sp³, and sp³-sp³ C—C cross-coupling reactions.

Metal-Catalyzed Cross-Coupling Reactions with Ligand L1

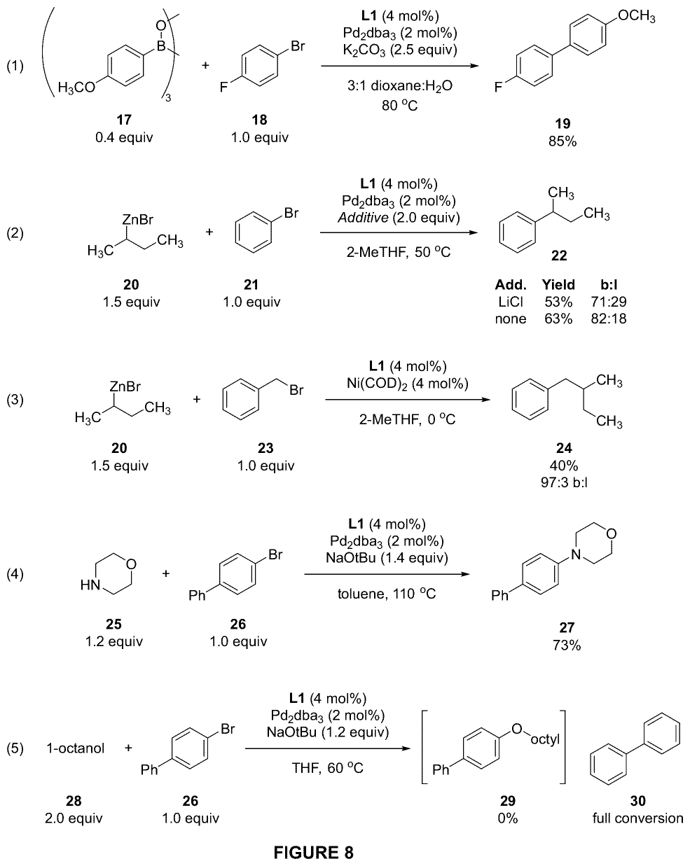

The cross-coupling reactions were first screened with achiral ligand L1 (FIG. 8). L1 catalyzed the aryl-aryl Suzuki-Miyaura cross-coupling of aryl boroxine 17 and aryl bromide 18 in an 85% yield (Reaction 1, FIG. 8). Additionally, the Negishi cross-coupling of sec-butylzinc bromide 20 with bromobenzene 21 yielded the cross-coupling product in 63% yield and a branched-to-linear ratio of 82:18. Notably, when the reaction was performed with a lithium chloride additive, the overall yield decreased to 53% and the branched-to-linear ratio decreased to 71:29 (Reaction 2, FIG. 8). Ligand L1 also effected the nickel-catalyzed sp³-sp³ Negishi cross-coupling of sec-butylzinc bromide 20 and benzyl bromide 23 in 40% yield and a 97:3 branched- to-linear ratio (Reaction 3, FIG. 8). A benzylic bromide was specifically chosen to be the electrophile in this reaction because nickel-catalyzed cross-coupling reactions are known to proceed via radical pathways, and benzylic radicals are more stable than alkyl radicals. Achieving this sp³ sp³ cross-coupling with such a high b:l ratio is very challenging using current synthetic methods.

Carbon-heteroatom cross-coupling reactions were also tested with L1. Thus, it was shown that phosphine-urea ligands are useful catalysts in Buchwald-Hartwig cross-coupling reactions. The palladium-catalyzed cross-coupling of morpholine 25 and 4-bromobiphenyl 26 proceeded to form the C—N bond in a 73% yield (Reaction 4, FIG. 8). Unfortunately, initial tests of C—O cross-couplings did not produce any of the desired product. The cross-coupling of 1-octanol 28 and 4-bromobiphenyl 26 produced only biphenyl 30 as a byproduct (Reaction 5, FIG. 8).

Cross-Coupling Reactions with Ligands L3 and L4

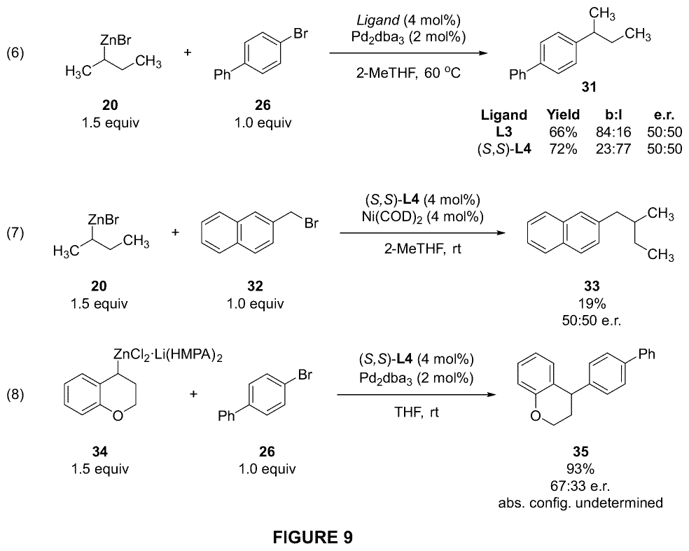

In addition to the experiments above with achiral phosphine-urea ligands, cross-couplings with chiral ligands were also screened for enantioselectivity (FIG. 9). The two chiral phosphine-urea ligands L3 and L4 were tested in Negishi couplings of racemic secondary alkylzinc reagents. Initial tests focused on attempts to enantioselectively cross-couple racemic sec-butylzinc bromide 20, as this is one of the most challenging substrates to effect an enantioselective transformation upon. Unfortunately, these reactions did not give the product with any enantiomeric excess. The cross-couplings of 20 with 26 using ligands L3 and (S,S)-L4 produced good yields of the cross-coupling product but without any optical activity (Reaction 6, FIG. 9). The nickel-catalyzed sp³ sp³ cross-coupling of 20 with 32 using (S,S)-L4 also gave the product in a 50:50 e.r. (Reaction 7, FIG. 9).

Palladium-catalyzed sp²-sp³ cross-couplings, L1 and L3 give similar branched-to-linear ratios of approximately 8:2 while L4 yields an extremely poor branched-to-linear ratio of 1:9. This indicates that reductive elimination from L1 or L3 is much faster than from L4. This is likely a result of the difference in steric environments at the phosphorus atom. L1 and L3 are both extremely bulky di-tert-butylphosphines while L4 is a slightly less encumbered diphenylphospholane. Studies have shown that undesired isomerization of secondary alkyl nucleophiles in cross-coupling reactions can be mediated by tuning the steric environment of the ligand. This suggests that phosphine-urea ligands can be tuned to increase reductive elimination rates.

Finally, a successful enantioselective cross-coupling was achieved using (S,S)-L4. A racemic 4-zincated chromane reagent 34 was cross-coupled to 26 with an e.r. of 67:33 (Reaction 8, FIG. 9). This result indicates that with the right choices of substrate and ligand, enantioselective transformations are possible in this catalytic system.

### Comparison of Chiral Phosphine-Urea Ligands to Commercially Available Chiral Ligands

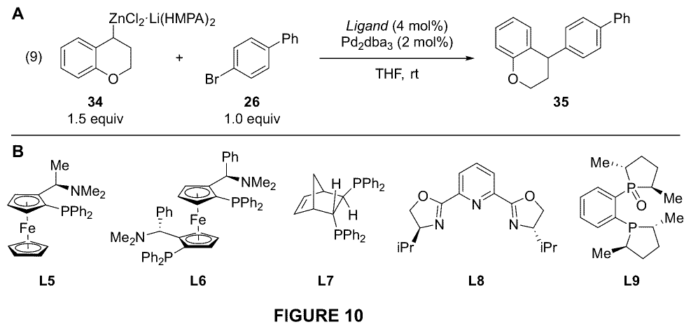

Phosphine-urea ligands were compared to commercially available chiral ligands (FIG. 10). PPFA L5, MandyPhos L6, NorPhos L7, PyBox L8, and BozPhos L9 (mono-oxide of DuPhos) were purchased from commercial suppliers and an experiment was conducted to compare the relative enantioselectivities and yields of these ligands with phosphine-urea ligand L4. The cross-coupling of racemic 4-zincated chromane 34 with 26 was tested with each ligand. NorPhos L7 gave only a 6% yield of the cross-coupling product, which was not high enough to collect accurate enantioselectivity data with that ligand. MandyPhos L6 and BozPhos L9 also produced poor yields of the product at 8% and 14%, respectively, and both had low enantioselectivities below 60:40 e.r. PyBox L8 gave a slightly improved yield over L6, L7, and L9 at 21%, but the enantioselectivity was within the margin of error of 50:50 e.r. The best result of any of the commercial ligands was PPFA L5, which yielded 36% of the cross-coupling product at 33:67 e.r. This e.r. was identical to that achieved by (R,R)-L4, but L4 gave a vastly superior yield of 93%, making it overall better than all of the commercial ligands that were tested. Table 1 demonstrates the yields for Reaction 9 as shown in FIG. 10 for each of the ligands tested:

TABLE 1
Results for Reaction 9 (FIG. 10)

| Entry | Ligand | Yield 35 (%) | e.r. |
|---|---|---|---|
| 1 | (R,R)-L4 | 93 | 33:67 |
| 2 | L5 | 36 | 33:67 |
| 3 | L6 | 8 | 57:43 |
| 4 | L7 | 6 | — |
| 5 | L8 | 21 | 51:49 |
| 6 | L9 | 14 | 59:41 |

¹H NMR yields by integration relative to a 1,3,5-trimethoxybenzene internal standard.

### Comparisons for Effect of Urea Group on Negishi Cross-Coupling Reaction Outcomes

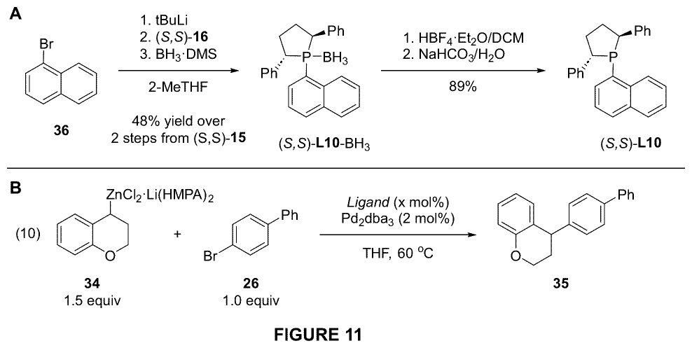

Comparison experiments were also conducted to determine what effect, if any, the urea group has on Negishi cross-coupling reaction outcomes. To perform these experiments, phosphine ligand (S,S)-L10 was synthesized which is analogous to (S,S)-L4 but does not contain a urea group (FIG. 11). (S,S)-L10 was synthesized by lithium-halogen exchange of 1-bromonaphthalene 36 and trapping with (S,S)-16, followed by protection of the phosphine with borane to allow for (S,S)-L10-BH₃ to be purified by chromatography without oxidation. The purified (S,S)-L10-BH₃ was deprotected with tetrafluoroboric acid and sodium bicarbonate to give (S,S)-L10. Results of Reaction 10 as shown in FIG. 11 are shown in Table 2 below:

TABLE 2
Results for Reaction 10 (FIG. 11)

| Entry | Ligand | L:Pd | Yield 35 (%) | e.r. |
|---|---|---|---|---|
| 1 | (R,R)-L4 | 1:1 | 69 | 33:67 |
| 2 | (S,S)-L10 | 1:1 | 74 | 65:35 |
| 3 | (R,R)-L4 | 2:1 | 85 | 31:69 |
| 4 | (S,S)-L10 | 2:1 | 36 | 58:42 |

¹H NMR yields by integration relative to a 1,3,5-trimethoxybenzene internal standard.

(R,R)-L4 and (S,S)-L10 were directly compared in the cross-coupling of chroman-4-ylzinc chloride 34 and 4-bromobiphenyl 26 (FIG. 11). When a 1:1 L:Pd ratio was used, L4 and L10 gave similar results in both yield and e.r., with L10 having a slightly higher yield and L4 having a slightly higher e.r. Based on this result, the urea group does not seem to greatly affect the yield or e.r. However, when 2:1 L:Pd was used, L4 performed significantly better than L10 with a yield of 85% and an e.r. of 31:69.

The effects of different ratios of ligands to palladium with both ligands were also observed. With ligand (R,R)-L4, a 2:1 L:Pd ratio gave a moderately higher yield than 1:1 L:Pd, increasing from 69% to 85%, but the change in L:Pd did not significantly affect the e.r. However, with (S,S)-L10, changing from 1:1 L:Pd to 2:1 L:Pd resulted in a steep decrease in yield and c.r.

### Material and Methods

Reactions were performed using glassware that had been flame-dried under vacuum or oven-dried (120° C.) overnight. Unless otherwise specified, all reactions were conducted under an inert atmosphere using nitrogen connected to a drying tube equipped with phosphorous pentoxide, calcium sulfate, and potassium hydroxide.

### Compound Suppliers

Reaction solvents THF (Sigma, inhibitor-free), Et₂O (VWR, inhibitor-free), toluene (Sigma), acetonitrile (Sigma), dichloromethane (DCM) (Fischer, inhibitor-frec), methanol (MeOH) (Sigma) were purified by a solvent purification system. 2-Methyltetrahydrofuran was purchased from Sigma and purified by distillation over potassium immediately before use. ACS grade extraction and chromatography solvents were purchased from Sigma. Anhydrous DMF, Sodium hydride, potassium hydride, sodium bicarbonate, tert-butyl lithium (1.7 M in pentane), sec-butyl lithium (1.6 M in cyclohexane), n-butyl lithium (2.5 M in hexanes), anhydrous dioxane, triethylamine, acetic acid, benzyl bromide, bromobenzene, 1-bromooctane, 4-methyl-2-nitroaniline, borane-tetrahydrofuran complex, borane dimethylsulfide complex, sulfuric acid, sodium metal, diisobutylaluminum hydride (1.0 M in hexane), tetrafluoroboric acid diethyl ether complex, 2-bromobutane, and zinc(II) chloride were all purchased from Sigma. Hexamethylphosphoramide, sodium tert-butoxide, Trimethylsilyl trifluoromethanesulfonate, tin(II) chloride, 1,3,5-trimethoxybenzene, (R)-pulegone, chlorotrimethylsilane, 1-Bromo-4-fluorobenzene, 4-bromobiphenyl, and 1,2-dibromocthane were all purchased from Oakwood Chemical. Zinc powder (99.9%, 325 mesh), aluminum trichloride, bis(1,5-cyclooctadiene)nickel(0), lithium chloride, RuPhosPdG4, and [1-(2R,5R)-2,5-dimethylphospholanyl]-[2-(2R,5R)-2,5-dimethylphospholanyl-1-oxide]benzene ((R,R)-Me-BozPhos, L9) were purchased from Strem Chemical. (R)—N,N-Dimethyl-1-[(R)-2-(diphenylphosphino)ferrocenyl]ethylamine ((R)-(S)-PPFA, L5), (R,R)-2,2′-Bis[(R)-(N,N-dimethylamino)(phenyl)methyl]-1,l′-bis(diphenylphosphino)ferrocene ((R)-Ph-Mandyphos, L6), (1R,4S,5R,6R)-5,6-Bis(diphenylphosphancyl)bicyclo[2.2.1]hept-2-cnc ((R,R)-norphos, L7), 2,6-Bis((S)-4-isopropyl-4,5-dihydrooxazol-2-yl)pyridine ((S,S)-iPr-PyBox, L8), and 4-chromanone were purchased from AmBeed. Oxalyl chloride, methyl iodide, phosphoryl chloride, cyclohexanone, dichloro(dimethylamino)phosphine, cetylpyridium chloride monohydrate, and 1-octanol were purchased from Alfa Acsar. Ethanol, urea, and morpholine were purchased from Fischer. Trans, trans-1,4-diphenyl-1,3-butadiene was purchased from Acros Organics. Quinine, 2-(bromomethyl)naphthalene, and 1-bromonaphthalene were purchased from Combi-Blocks. Hydrochloric acid (12.1 M) was purchased from VWR. Pyrrolidine, 1,2,4,5-tetramethylbenzene, and 1,2,3,4-tetrahydroquinoline were purchased from BeanTown Chemical. Di-tert-butylchlorophosphine and dicyclohexylchlorophosphine were purchased from DalChem. 5% palladium on carbon was manufactured by Engelhard. All deuterated solvents for NMR experiments were purchased from Cambridge Isotope Labs. Pd₂dba₃ was prepared from PdCl₂ and dibenzylideneacetone following a literature procedure from Fairlamb 2004, which is incorporated by reference herein.

### NMR Spectroscopy

¹H, ¹³C, ³¹P and ¹⁹F NMR spectra for compound characterization were recorded on Bruker Avance Neo 400 MHz NMR spectrometer (¹H, 400 MHz; ¹³C, 101 MHz; ¹⁹F, 376 MHz; ³¹P 162 MHZ) or Varian VnmrS 500 MHz NMR spectrometer (¹H, 500 MHz; ¹³C 126 MHz; ¹⁹F 470 MHz; ³¹P 202 MHz). Spectra are referenced to residual chloroform (¹H 7.26 ppm; ¹³C 77.16 ppm), trifluorotoluene (−63.72 ppm, ¹⁹F), and phosphoric acid (0 ppm, ³¹P). Chemical shifts are reported in ppm, multiplicities are indicated by s (singlet), d (doublet), t (triplet), q (quartet), p (pentet), h (hextet), m (multiplet) and br (broad). Coupling constants, J, are reported in Hertz (Hz).

### Infrared Spectroscopy (IR)

Infrared spectra were recorded on IRAffinity-1S spectrometer equipped with a diamond laminate ATR. Infrared spectra were acquired from neat samples. If required, substances were dissolved in DCM prior to direct application on the ATR unit.

### Mass Spectrometry (MS)

High-resolution mass spectra were recorded on a Thermo Scientific Q Exactive Focus High-resolution Orbitrap instrument configured for routine small molecule analysis. Analysis was carried out in either electrospray ionization (ESI) or atmospheric pressure chemical ionization (APCI) positive ion modes.

### Gas Chromatography (GC)

Gas Chromatography (GC) spectra were recorded on an Agilent 8860 GC System using a flame ionization detector (FID) or mass spectrometer (MS). The standard method for reaction monitoring holds a temperature of 50° C. for 3 min and ramps up (10° C./min) to a final temperature of 275° C. which is held for 5 min.

### High Performance Liquid Chromatography (HPLC)

Chiral HPLC analysis was performed on an Agilent 1260 Infinity II analytical HPLC system using a DIACEL Chiralpak OD-H or AD-H column with hexanes or hexanes/IPA as an eluent. Preparative HPLC was performed on an Agilent 1290 Infinity II preparative HPLC system using an Agilent 5 Prep-C18 50×50.0 mm column with MeCN/MeOH as an eluent.

### EXAMPLES

### Example 1. Synthesis of 2-bromo-4-methyl-6-nitroaniline (2, FIG. 5)

A 1-L 3-neck flask was charged with 4-methyl-2-nitroaniline (164.0 mmol, 25.0 g, 1.0 equiv) and glacial acetic acid (250 mL), and the mixture was heated to 60° C. until homogeneous. The solution was allowed to cool and a NaOH bubbler was attached to neutralize HBr gas. Bromine (197.0 mmol, 10.1 mL, 1.2 equiv) was added slowly at room temperature via an addition funnel, resulting in the formation of an orange precipitate. The slurry was poured into a mixture of ice and 1 M NaHSO₃ (500 mL), and diluted with water to 2 L. The precipitate was collected by vacuum filtration, dissolved in DCM, and washed with water (3×100 mL) to remove residual acetic acid. The organic layer was dried over Na₂SO₄ and concentrated under reduced pressure to give the title compound 2 (36.8 g, 97%) as an orange solid. The product was used without further purification. Spectral data were in accordance with literature reports such as those of Yasui 2006 (Yasui, Y.; Frantz, D. K.; Siegel, J. S., Synthesis of 4,4′-Bisaryl-2,2′-bisbenzimidazoles as Building Blocks for Supramolecular Structures. Org. Lett. 2006, 8, 4989-4992), which is herein incorporated by reference. Results were as follows:

¹H NMR (400 MHZ, CDCl₃) δ 7.90 (dd, J=2.0, 1.0 Hz, 1H), 7.52 (d, J=2.1 Hz, 1H), 6.31 (s, 2H), 2.25 (s, 3H).

¹³C NMR (101 MHZ, CDCl₃) δ 140.2, 140.0, 132.6, 126.5, 125.5, 112.0, 19.9.

### Example 2. Synthesis of 2-bromo-N-cyclohexyl-4-methyl-6-nitroaniline (3, FIG. 5)

A 1-L 3-neck flask was charged with 2-bromo-4-methyl-6-nitroaniline 2 (120.0 mmol, 27.73 g, 1.0 equiv) and cyclohexanone (180.0 mmol, 18.64 mL, 1.5 equiv). The flask was purged with N₂ and anhydrous DMF (180 mL) was added. The solution was cooled to 0° C. and trimethylsilyl trifluoromethanesulfonate (300.0 mmol, 54.30 mL, 2.5 equiv) was added. The reaction was allowed to warm to room temperature and stirred for 16 hours. The mixture was cooled to 0° ° C. and borane-dimethylsulfide complex (120.0 mmol, 11.35 mL, 1.0 equiv) was added via an addition funnel at a rate of ˜12 drops per minute. The reaction was warmed to room temperature and quenched with deionized water (100 mL) followed by saturated aqueous NaHCO₃ (200 mL). EtOAc (200 mL) was added and the layers were separated. The aqueous layer was extracted twice with EtOAc (200 mL). The combined organic layers were washed with brine (3×200 mL), dried over Na₂SO₄, and evaporated under reduced pressure. The concentrate was purified through a plug of silica in 50:50 DCM:hexanes, reconcentrated, and heated to 70° C. under reduced pressure in a vacuum sublimator to remove volatile impurities. The final product 3 was obtained as a viscous red oil (35.85 g, 95%). Results were as follows:

¹H NMR (400 MHZ, CDCl₃) δ 7.73 (dd, J=2.1, 0.9 Hz, 1H), 7.56 (d, J=2.1 Hz, 1H), 3.56 (tt, J=10.0, 3.8 Hz, 1H), 2.29 (s, 3H), 1.99-1.83 (m, 2H), 1.78-1.63 (m, 2H), 1.63-1.54 (m, 1H), 1.41-1.10 (m, 4H).

¹³C NMR (101 MHZ, CDCl₃) δ 141.1, 140.5, 140.4, 130.3, 125.7, 116.8, 55.8, 34.3, 25.7, 25.0, 20.1.

HRMS (APCI) calc. C₁₃H₁₇BrN₂O₂ [M+H]⁺: 313.0546 Found. 313.0544.

IR (Diamond-ATR, neat): \tilde{ν}ₘₐₓ: 712, 731, 762, 866, 937, 1069, 1094, 1142, 1217, 1240, 1261, 1327, 1474, 1526, 2853, 2928, 3080, 3356 cm⁻¹.

TLC (50% DCM in hexanes): R_{f}=0.76 (UV).

### Example 3. Synthesis of 4-bromo-1-cyclohexyl-6-methyl-1,3-dihydro-2H-benzo[d]imidazol-2-one (4, FIG. 5)

### Step 1: Synthesis of 3-bromo-N1-cyclohexyl-5-methylbenzene-1,2-diamine

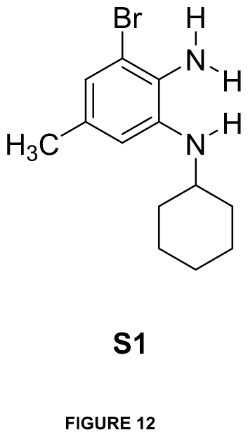

A 500-mL 3-neck flask was charged with 2-bromo-N-cyclohexyl-4-methyl-6-nitroaniline 3 (114.5 mmol, 35.85 g, 1.0 equiv) and 200-proof ethanol (146 mL). Concentrated hydrochloric acid (37 mL) was added and the flask was purged with N2. The reaction was cooled to 0° C. and SnCl₂·2H₂O (572.3 mmol, 129.1 g, 5.0 equiv) was added in portions, resulting in a color change from bright red to pale yellow. The reaction was heated to 65° C. for 16 hours and was found to be incomplete by TLC analysis (10% EtOAc/hexanes). Additional SnCl₂·2H₂O (114.5 mmol, 25.8 g, 1.0 equiv) and HCl (7.3 mL) were added, and the reaction was heated to 65° C. for 4 hours. The reaction was quenched by pouring into a stirring mixture of ice and 6 M NaOH (150 mL). The resulting slurry was poured into a stirring suspension of celite (750 g) in DCM (2 L). The mixture was filtered and the solid was washed with DCM (3×1 L). The layers were separated and the aqueous layer was extracted with DCM (2×100 mL). The combined organic layers were dried over Na₂SO₄, filtered through cotton, and concentrated under reduced pressure to give S1 (32.4 g, quant.) as a yellow solid (see FIG. 12 for the structure of S1). The crude product was used without further purification.

### Step 2: Synthesis of 4-bromo-1-cyclohexyl-6-methyl-1,3-dihydro-2H-benzo[d]imidazol-2-one (4, FIG. 5)

A 250-mL round-bottom flask was charged with urea (744.0 mmol, 44.7 g, 6.5 equiv) and 3-bromo-N1-cyclohexyl-5-methylbenzene-1,2-diamine S1 (114.5 mmol, 32.4 g, 1.0 equiv) (S1, FIG. 12). The flask was purged with N₂ and fitted with an air condenser and H₂O bubbler. The reaction was heated to 160° C. with strong stirring for 6 hours. DCM (100 mL), water (100 mL), and concentrated HCl (10 mL) were added and the mixture was filtered. The solid was washed with DCM (100 mL) and water (100 mL). The filtrate was collected and the layers were separated. The aqueous layer was extracted with DCM (3×100 mL). The combined organic layers were dried over Na₂SO₄, filtered through cotton, and concentrated under reduced pressure. The concentrate was washed with boiling methanol to give 4 (10.27 g) as a white solid. The washings were reconcentrated and the crude solid was recrystallized from hot methanol to give an additional 10.65 g for a combined yield of 20.92 g (59%). Results were as follows:

¹H NMR (400 MHZ, CDCl₃) δ 8.96 (s, 1H), 6.92 (s, 1H), 6.83 (s, 1H), 4.16 (tt, J=12.4, 3.9 Hz, 1H), 2.31 (s, 3H), 2.13-1.98 (m, 2H), 1.87-1.76 (m, 2H), 1.72-1.65 (m, 2H), 1.45-1.31 (m, 2H), 1.28-1.15 (m, 1H).

¹³C NMR (101 MHZ, CDCl₃) δ 154.2, 132.1, 130.3, 125.4, 123.9, 109.0, 101.8, 53.1, 30.1, 26.0, 25.4, 21.5.

HRMS (APCI) calc. C₁₄H₁₇BrN₂O [M+H]⁺: 309.0597. Found 309.0595.

IR (Diamond-ATR, neat): \tilde{ν}ₘₐₓ: 588, 638, 721, 748, 818, 1682, 2847, 2930, 3034, 3117 cm⁻¹.

### Example 4. Synthesis of 4-bromo-1-cyclohexyl-3,6-dimethyl-1,3-dihydro-2H-benzo[d]imidazol-2-one (5, FIG. 5)

A 1 L 3-neck flask was charged with 4-bromo-1-cyclohexyl-6-methyl-1,3-dihydro-2H-benzo[d]imidazol-2-one 4 (61.5 mmol, 19.02 g, 1.0 equiv) and anhydrous DMF (300 mL) under a N₂ atmosphere. The mixture was cooled to 0° C. and potassium hydride (73.8 mmol, 2.96 g, 1.2 equiv) was added in portions as a solid. The reaction was stirred at 0° C. for 1 hour. Methyl iodide (73.8 mmol, 4.59 mL, 1.2 equiv) was added dropwise and the reaction was allowed to warm to room temperature. The reaction was quenched with water (200 mL) and brine (100 mL) and extracted with EtOAc (3×200 mL). The combined organic layers were washed with brine (3×200 mL), dried over Na₂SO₄, and concentrated under reduced pressure. The concentrate was recrystallized from hexanes to give 5 (13.91 g) as a white solid. The filtrate was concentrated and recrystallized from methanol to give an additional 4.14 g for a combined yield of 18.05 g (91%). Analysis results were as follows:

¹H NMR (400 MHZ, CDCl₃) δ 6.99 (s, 1H), 6.87 (s, 1H), 4.22 (tt, J=12.5, 3.9 Hz, 1H), 3.71 (s, 3H), 2.35 (s, 3H), 2.14 (qd, J=12.7, 3.7 Hz, 2H), 1.94-1.87 (m, 2H), 1.84-1.69 (m, 3H), 1.50-1.35 (m, 2H), 1.34-1.21 (m, 1H).

¹³C NMR (101 MHZ, CDCl₃) δ 154.3, 131.9, 130.7, 126.0, 125.6, 108.8, 101.4, 53.5, 30.1, 29.8, 26.1, 25.4, 21.2.

HRMS (APCI) calc. C₁₅H₁₉BrN₂O [M+H]⁺: 323.0754. Found 323.0752.

IR (Diamond-ATR, neat): \tilde{ν}ₘₐₓ: 583, 590, 627, 696, 746, 835, 1053, 1690, 2851, 2932 cm⁻¹.

### Example 5. Synthesis of (R)-3-methylcyclohexanone (7, FIG. 6)

(R)-3-methylcyclohexanone 7 was prepared according to a literature procedure from Vashchenko 2012, (Vashchenko, E. V.; Knyazeva, I. V.; Krivoshey, A. I.; Vashchenko, V. V., Retro-aldol reactions in micellar media. Monatsh. Chem. 2012, 143, 1545-1549), which is herein incorporated by reference. Spectral data were in accordance with literature reports such as Nannini 2018 (Nannini, L. J.; Nemat, S. J.; Carreira, E. M., Total Synthesis of (+)-Sarcophytin. Angew. Chem., Int. Ed. 2018, 57, 823-826), which is herein incorporated by reference, and were are follows:

¹H NMR (400 MHZ, CDCl₃) δ 2.31-2.19 (m, 2H), 2.18-2.08 (m, 1H), 1.99-1.86 (m, 2H), 1.86-1.70 (m, 2H), 1.63-1.48 (m, 1H), 1.31-1.17 (m, 1H), 0.92 (d, J=6.4 Hz, 3H).

¹³C NMR (101 MHz, CDCl₃) δ 211.6, 49.9, 41.0, 34.1, 33.2, 25.2, 22.0.

### Example 6. 2-bromo-4-methyl-N-((1S,3R)-3-methylcyclohexyl)-6-nitroaniline (8, FIG. 6)

A 500-mL 3-neck flask was charged with 2-bromo-4-methyl-6-nitroaniline 2 (45.0 mmol, 10.40 g, 1.0 equiv) and anhydrous DMF (69 mL) under a N₂ atmosphere. The solution was cooled to 0° C. and trimethylsilyl trifluoromethanesulfonate (300.0 mmol, 54.30 mL, 2.5 equiv) was added, followed by (R)-3-methylcyclohexanone 7 (67.5 mmol, 8.27 mL, 1.5 equiv). The reaction was heated to 50° C. for 3 hours. The mixture was cooled to 0° C. and borane-tetrahydrofuran complex (45.0 mmol, 45 mL, 1.0 equiv) was added. The reaction was warmed to room temperature overnight and quenched with deionized water (50 mL) followed by saturated aqueous NaHCO₃ (100 mL). EtOAc (100 mL) was added and the layers were separated. The aqueous layer was extracted with EtOAc (2×200 mL). The combined organic layers were washed with brine (3×200 mL), dried over Na₂SO₄, and evaporated under reduced pressure to give a viscous red oil. The concentrate was purified through a plug of silica in 5% EtOAc/hexanes, reconcentrated, and heated under reduced pressure in a bulb-to-bulb distillation apparatus to remove volatile impurities. The product 8 was obtained as an inseparable mixture of diastercomers (12.18 g, 83%, 64:36 d.r.). Spectral results were as follows:

¹H NMR (500 MHZ, CDCl₃): Unresolved diastercomers δ 7.75-7.69 (m, 1H), 7.57-7.52 (m, 1H), 7.22-4.91 (br s, 1H), 4.06-3.98 (m, 0.4H), 3.57-3.47 (m, 0.6H), 2.33-2.23 (m, 3H), 1.99-1.90 (m, 1H), 1.76-1.57 (m, 2H), 1.55-1.34 (m, 2H), 1.34-1.20 (m, 1H), 1.05-0.93 (m, 1H), 0.90-0.85 (m, 3H), 0.84-0.73 (m, 1H).

¹³C NMR (126 MHZ, CDCl₃): Unresolved diastercomers δ 141.1, 140.6, 140.5, 140.4, 140.4, 140.3, 130.3, 129.6, 125.7, 125.6, 116.9, 116.0, 56.3, 51.7, 43.3, 39.4, 34.4, 34.2, 33.8, 32.2, 31.2, 27.1, 25.1, 22.5, 21.7, 20.5, 20.0, 20.0.

HRMS (APCI) calc. C₁₄H₁₉BrN₂O₂ [M+H]⁺: 327.0703. Found 327.0700.

IR (Diamond-ATR, neat): \tilde{ν}max: 712, 731, 762, 866, 935, 1088, 1217, 1248, 1325, 1489, 1528, 2845, 2922, 3356 cm⁻¹.

TLC (5% EtOAc in hexanes): R/=0.57 (UV).

### Example 7. Synthesis of 4-bromo-6-methyl-1-((1S,3S)-3-methylcyclohexyl)-1,3-dihydro-2H-benzo[d]imidazol-2-one (9, FIG. 6)

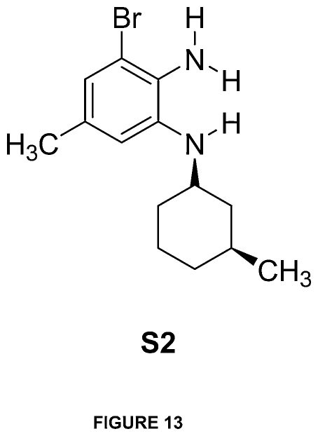

### Step 1: Synthesis of 3-bromo-5-methyl-N1-((1S,3S)-3-methylcyclohexyl)benzene-1,2-diamine (S2, FIG. 13)

A 50-mL round-bottom flask was charged with 2-bromo-4-methyl-N-((1S,3R)-3-methylcyclohexyl)-6-nitroaniline 8 (6.1 mmol, 2.00 g, 1.0 equiv) and 200-proof ethanol (8 mL). Concentrated hydrochloric acid (2 mL) was added and the flask was purged with N2. The reaction was cooled to 0° ° C. and SnCl₂·2H₂O (30.6 mmol, 6.90 g, 5.0 equiv) was added in portions, resulting in a color change from bright red to pale yellow. The reaction was heated to 60° C. for 16 hours. The reaction was quenched by pouring into a stirring mixture of ice and 2 M NaOH (30 mL). The resulting slurry was poured into a stirring suspension of celite (100 g) in DCM (200 mL). The mixture was filtered and the solid was washed with DCM (3×50 mL). The layers were separated and the aqueous layer was extracted with DCM (2×50 mL). The combined organic layers were, dried over Na₂SO₄, filtered through cotton, and concentrated under reduced pressure to give S2 (1.75 g, 96%) (structure shown in FIG. 13) as a yellow solid. The product was used without further purification.

### Step 2: Synthesis of 4-bromo-6-methyl-1-((1S,3S)-3-methylcyclohexyl)-1,3-dihydro-2H-benzo[d]imidazol-2-one (9, FIG. 6)

A 100-mL round-bottom flask was charged with urea (123.0 mmol, 7.40 g, 5.0 equiv) and 3-bromo-5-methyl-N1-((1S,3S)-3-methylcyclohexyl)benzene-1,2-diamine S2 (24.6 mmol, 7.33 g, 1.0 equiv) (FIG. 13). The flask was purged with N₂ and fitted with an air condenser and H₂O bubbler. The reaction was heated to 160° C. with strong stirring for 16 hours. The reaction was found to be incomplete by GC analysis. Additional urea (33.3 mmol, 2.0 g, 1.35 equiv) was added and the reaction was heated to 160° C. with strong stirring for 6 hours. DCM (50 mL), water (50 mL), and concentrated HCl (5 mL) were added and the flask was sonicated. The layers were separated and the aqueous layer was extracted with DCM (3×150 mL). The combined organic layers were dried over Na₂SO₄, and concentrated under reduced pressure. The concentrate was dissolved in hot methanol, filtered, and reconcentrated. The product was recrystallized from methanol to give 9 (3.96 g, 50%, 95:5 d.r.) (FIG. 6) as a white solid. Analysis results were as follows:

¹H NMR (400 MHZ, CDCl₃) δ 9.93 (s, 1H), 6.99 (s, 1H), 6.88 (s, 1H), 4.29 (tt, J=12.1, 4.2 Hz, 1H), 2.38 (s, 3H), 2.13-1.99 (m, 1H), 1.95-1.68 (m, 5H), 1.67-1.55 (m, 1H), 1.54-1.40 (m, 1H), 1.10-0.88 (m, 4H).

¹³C NMR (101 MHZ, CDCl₃) δ 154.8, 132.1, 130.3, 125.7, 124.1, 109.0, 102.1, 52.9, 38.6, 34.2, 32.7, 29.5, 25.4, 22.5, 21.5.

HRMS (APCI) calc. C₁₅H₁₉BrN₂O [M+H]⁺: 323.0754. Found 323.0751.

IR (Diamond-ATR, neat): \tilde{ν}ₘₐₓ: 675, 708, 752, 826, 1094, 1194, 1379, 1456, 1686, 2859, 2926, 2947, 3030, 3117 cm⁻¹.

### Example 8. Synthesis of 4-bromo-3,6-dimethyl-1-((1S,3S)-3-methylcyclohexyl)-1,3-dihydro-2H-benzo[d]imidazol-2-one (10, FIG. 6)

A 200-mL round-bottom flask was charged with 4-bromo-6-methyl-1-((1S,3S)-3-methylcyclohexyl)-1,3-dihydro-2H-benzo[d]imidazol-2-one 9 (11.8 mmol, 3.81 g, 1.0 equiv) and sodium hydride (58.9 mmol, 1.41 g, 5.0 equiv). The flask was cooled to 0° C. and anhydrous DMF (70 mL) was added quickly. The reaction was stirred at 0° C. for 2 hours. Methyl iodide (14.1 mmol, 2.01 g, 1.2 equiv) was added dropwise. The reaction was stirred for 2 hours and was allowed to warm to room temperature. The reaction was quenched with saturated aqueous NH₄Cl (100 mL) and extracted with EtOAc (3×100 mL). The combined organic layers were washed with brine (3×100 mL), dried over Na₂SO₄, and concentrated under reduced pressure. The residue was purified by a silica plug in 0→10% EtOAc/hexanes to give 10 (3.74 g, 94%, 95:5 d.r.) as a white solid. Spectral analysis results were as follows:

¹H NMR (400 MHZ, CDCl₃) δ 6.97 (s, 1H), 6.85 (s, 1H), 4.30-4.16 (m, 1H), 3.69 (s, 3H), 2.34 (s, 3H), 2.07 (qd, J=12.7, 3.9 Hz, 1H), 1.93-1.84 (m, 1H), 1.84-1.66 (m, 4H), 1.64-1.51 (m, 1H), 1.44 (qt, J=13.2, 3.6 Hz, 1H), 1.08-0.88 (m, 4H).

¹³C NMR (101 MHZ, CDCl₃) δ 154.3, 131.8, 130.6, 126.0, 125.6, 108.7, 101.4, 53.3, 38.4, 34.1, 32.8, 29.7, 29.3, 25.5, 22.4, 21.2.

HRMS (APCI) calc. C₁₆H₂₁BrN₂O [M+H]⁺: 337.0910. Found 337.0906.

IR (Diamond-ATR, neat): \tilde{ν}ₘₐₓ: 584, 671, 696, 746, 824, 1036, 1051, 1379, 1422, 1456, 1489, 1695, 2857, 2924 cm⁻¹.

TLC (10% EtOAc in hexanes): R_{f}=0.39 (UV).

### Example 9. Synthesis of (1s,2R,5S)-1-(dimethylamino)-1-oxo-2,5-diphenyl-2,5-dihydrophosphole (12, FIG. 7)

(1s,2R,5S)-1-(dimethylamino)-1-oxo-2,5-diphenyl-2,5-dihydrophosphole 12 was prepared according to a literature procedure reported in Guillen 2002 (Guillen, F.; Rivard, M.; Toffano, M.; Legros, J.-Y.; Daran, J.-C.; Fiaud, J.-C., Synthesis and first applications of a new family of chiral monophosphine ligand: 2,5-diphenylphosphospholanes. Tetrahedron 2002, 58, 5895-5904), which is herein incorporated by reference. Spectral data were in accordance with literature reports and were as follows:

¹H NMR (400 MHZ, CDCl₃) δ 7.35-7.19 (m, 10H), 6.55 (d, J=28.9 Hz, 2H), 4.31 (d, J=18.7 Hz, 2H), 1.88 (d, J=8.3 Hz, 6H).

³¹P NMR (162 MHZ, CDCl₃) δ 68.37.

### Example 10. Synthesis of (1s,2R,5S)-1-(dimethylamino)-1-oxo-2,5-diphenylphospholane (13, FIG. 7)

13 was prepared according to a modified literature procedure of that reported in Guillen 2002. A 200-mL Schlenk flask was charged with (1S,2R,5S)-1-(dimethylamino)-1-oxo-2,5-diphenyl-2,5-dihydrophosphole 12 (13.91 g, 46.78 mmol, 1.0 equiv), 5% palladium on carbon (4.98 g, 2.34 mmol, 5 mol %), and a stir bar. The flask was purged with N₂ and MeOH (65 mL) was added. A balloon of H₂ gas was attached to the gas inlet and the flask was purged with H₂. The mixture was heated to 50° C. with vigorous stirring for 16 hours. The mixture was filtered through celite and concentrated under reduced pressure. The residue was recrystallized from EtOAc/hexanes to give the desired product 13 as a tan solid (10.63 g, 76%). Spectral data were in accordance with literature reports (see Guillen 2002) and were as follows:

¹H NMR (400 MHZ, CDCl₃) δ 7.35-7.26 (m, 8H), 7.23-7.16 (m, 2H), 3.75-3.60 (m, 2H), 2.63-2.44 (m, 4H), 1.85 (d, J=8.2 Hz, 6H).

³¹P NMR (162 MHZ, CDCl₃) δ 66.84.

### Example 11. Synthesis of 1-hydroxy-1-oxo-2,5-trans-diphenylphospholane (14, FIG. 7)

14 was prepared according to a modified literature procedure of that reported in Guillen 2002. Specifically, a 200-mL Schlenk flask was charged with MeOH (64 mL) and a stir bar, purged with N2, and cooled to 0° C. in an ice bath. The flask was opened and sodium metal (128.0 mmol, 2.93 g, 5.0 equiv) was added under positive N₂ flow. The mixture was warmed to room temp and stirred until the sodium had completely reacted (˜30 min). The flask was opened and (1s,2R,5S)-1-(dimethylamino)-1-oxo-2,5-diphenylphospholane 13 (25.5 mmol, 7.63 g, 1.0 equiv) was added under positive N2 flow. The mixture was stirred for 30 minutes and 6 M HCl (153 mL) was added slowly. The resulting precipitate was collected by filtration and recrystallized from MeOH to give the product 14 as a white crystalline solid (4.19 g, 60%). Spectral data were in accordance with literature reports (see Guillen 2002) and were as follows:

¹H NMR (400 MHZ, MeOD) δ 7.44-7.18 (m, 10H), 4.88 (s, 1H), 3.42-3.21 (m, 2H), 2.54-2.33 (m, 2H), 2.29-2.04 (m, 2H).

³¹P NMR (162 MHZ, MeOD) δ 61.82.

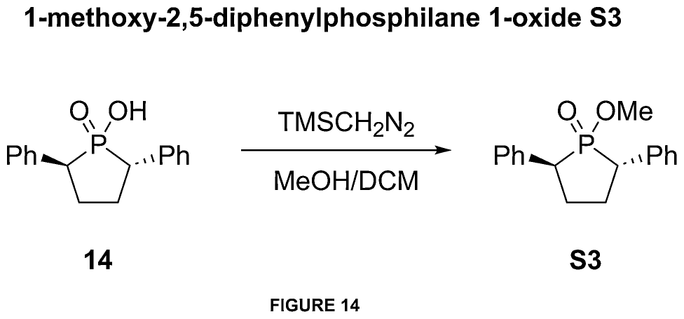

### Example 12. Synthesis of 1-methoxy-2,5-diphenylphospholane 1-oxide (S3, FIG. 14)

A dram vial was charged with 1-hydroxy-1-oxo-2,5-trans-diphenylphospholane 14 (39 μmol, 10.6 mg, 1.0 equiv), MeOH (0.25 mL), DCM (1.0 mL), and a stir bar. The vial was capped with a septa-cap and a vent needle was inserted. Trimethylsilyldiazomethane (2 M in hexanes) was added dropwise until a yellow color persisted in the vial (˜50 L). Glacial acetic acid was added dropwise until the yellow color completely faded to clear (˜1-2 drops). The reaction mixture was concentrated in vacuo to give the product. Spectral data were in accordance with literature reports (see Guillen 2002) and were as follows:

¹H NMR (400 MHZ, CDCl₃) δ 7.72-7.25 (m, 10H), 3.70-3.51 (m, 1H), 3.49-3.20 (m, 4H), 2.81-2.44 (m, 2H), 2.41-2.16 (m, 2H).

³¹P NMR (162 MHZ, CDCl₃) δ 65.29.

HPLC (±)-S3 (AD-H column, 80:20 hexanes/IPA, 2.0 mL/min) 3.63 min (50%), 4.56 min (50%).

### Example 13. Resolution of 1-hydroxy-1-oxo-2,5-trans-diphenylphospholane (14, FIG. 7)

Enantiomers were resolved according to a literature procedure reported in Guillen 2002, which is herein incorporated by reference. NMR spectra were identical to the (±)-14. Enantiomeric ratio was determined by HPLC analysis of S3 after reaction of 14 with TMSCH₂N₂. Analysis results were as follows:

HPLC (S,S)-S3 (DIACEL Chiralpak AD-H column, 80:20 hexanes/IPA, 2 mL/min) 3.63 min (1%), 4.56 min (99%).

HPLC (R,R)-S3 (AD-H column, 80:20 hexanes/IPA, 2 mL/min) 3.64 min (99%), 4.60 min (1%).

### Example 14. Synthesis of 2,5-Diphenyl-1-oxophospholane (15, FIG. 7)

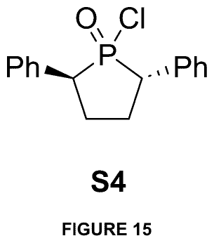

### Step 1: Synthesis of 2,5-Diphenyl-1-oxo-1-chlorophospholane S4 (FIG. 15)

S4 was prepared according to a literature procedure reported in Fox 2008, which is herein incorporated by reference. The crude product was used without purification. Procedure and spectra were identical for (±)-S4, (S,S)-S4, and (R,R)-S4 with the following result:

³¹P NMR (202 MHZ, DCM) δ 80.67.

### Step 2: Synthesis of 2,5-Diphenyl-1-oxophospholane 15

15 was prepared according to a literature procedure as reported in Fox 2008, which is herein incorporated by reference. Procedure and spectra were identical for (±)-15, (S,S)-15, and (R,R)-15 with the following results:

¹H NMR (400 MHZ, CDCl₃) δ 7.41-7.27 (m, 10H), 7.18 (dq, JPH=470 Hz, JHH=2.9 Hz, 1H), 3.66-3.49 (m, 1H), 3.34-3.22 (m, 1H), 2.71-2.48 (m, 2H), 2.45-2.31 (m, 1H), 2.09-1.94 (m, 1H).

³¹P NMR (162 MHZ, CDCl₃) δ 53.87.

### Example 15. Synthesis of 1-Chloro-2,5-diphenylphospholane (16, FIG. 7)

16 was prepared according to a literature procedure reported in Fox 2008 (Fox, M. E.; Jackson, M.; Lennon, I. C.; Klosin, J.; Abboud, K. A., Bis-(2,5-diphenylphospholanes) with sp² Carbon Linkers: Synthesis and Application in Asymmetric Hydrogenation. J. Org. Chem. 2008, 73, 775-784), which is herein incorporated by reference. The crude product was used without purification. Procedure and spectra were identical for (±)-16, (S,S)-16, and (R,R)-16 with the following result:

³¹P NMR (202 MHZ, toluene) δ 138.22.

### Example 16. Synthesis of L1 (L1, FIG. 5)

A 25-mL Schlenk flask was charged with 4-bromo-1-cyclohexyl-3,6-dimethyl-1,3-dihydro-2H-benzo[d]imidazol-2-one 5 (2.0 mmol, 646.0 mg, 1.0 Equiv) and 2-MeTHF (8 mL) under a N₂ atmosphere. The mixture was cooled to −78° C. and/BuLi (4.0 mmol, 2.42 mL, 2.0 equiv) was added dropwise. The reaction was allowed to warm to room temperature and tBu₂PCI (2.0 mmol, 361.0 mg, 1.0 equiv) was added. The reaction was heated to 50° C. for 1 hour and was quenched with water (10 mL). The mixture was extracted with EtOAc (3×15 mL). The combined organic layers were dried over Na₂SO₄ and evaporated under reduced pressure. The crude product was purified by silica column chromatography in 10→15% EtOAc/hexanes to give L1 as a white solid (487 mg, 63%). Analysis results were as follows:

¹H NMR (500 MHZ, CDCl₃) δ 7.21 (s, 1H), 6.93 (s, 1H), 4.22 (tt, J=12.5, 4.0 Hz, 1H), 3.82 (d, J=2.7 Hz, 3H), 2.39 (s, 3H), 2.19 (qd, J=12.7, 3.6 Hz, 2H), 1.94-1.80 (m, 4H), 1.73 (d, J=12.6 Hz, 1H), 1.43 (qt, J=13.0, 3.4 Hz, 2H), 1.19 (d, J=12.7 Hz, 19H).

¹³C NMR (126 MHz, CDCl₃) δ 154.8, 133.5 (d, J=23.5 Hz), 129.3 (d, J=9.1 Hz), 128.7, 128.3, 118.2 (d, J=33.2 Hz), 110.0, 53.3, 34.1 (d, J=30.8 Hz), 32.9 (d, J=23.2 Hz), 30.9 (d, J=15.5 Hz), 30.1, 26.2, 25.5, 21.7.

³¹P NMR (162 MHZ, CDCl₃) δ 9.87.

HRMS (APCI) calc. C₂₃H₃₇N₂OP [M+H]⁺: 389.2716. Found 389.2711.

IR (Diamond-ATR, neat): \tilde{ν}ₘₐₓ: 698, 750, 810, 841, 1063, 1385, 1449, 1699, 2859, 2938 cm⁻¹.

TLC (10% EtOAc in hexanes): R_{f}=0.34 (UV).

### Example 17. Synthesis of L2 (L2, FIG. 5)

A 10-mL round-bottom flask was charged with 4-bromo-1-cyclohexyl-3,6-dimethyl-1,3-dihydro-2H-benzo[d]imidazol-2-one 5 (0.5 mmol, 161.6 mg, 1.0 Equiv) and 2-MeTHF (2 mL) under a N₂ atmosphere. The mixture was cooled to −78° C. and tBuLi (1.0 mmo, 588 μL, 2.0 equiv) was added dropwise. The reaction was allowed to warm to room temperature and Cy₂PCI (0.525 mmol, 122 mg, 1.05 equiv) was added as a solution in 2-MeTHF (1 mL). The reaction was stirred for 1 hour and allowed to warm to room temperature. The reaction was quenched with saturated aqueous NH₄Cl (5 mL) and extracted with EtOAc (3×10 mL). The combined organic layers were dried over Na₂SO₄ and evaporated under reduced pressure. The crude product was purified by silica column chromatography in 10% EtOAc/hexanes to give L2 as a white solid (63.8 mg, 29%). Analysis results were as follows:

¹H NMR (400 MHZ, CDCl₃) δ 6.92 (s, 2H), 4.23 (tt, J=12.4, 3.9 Hz, 1H), 3.76 (d, J=2.2 Hz, 3H), 2.40 (s, 3H), 2.19 (qd, J=12.5, 3.5 Hz, 2H), 1.98-1.61 (m, 15H), 1.55 (d, J=14.1 Hz, 2H), 1.51-1.22 (m, 6H), 1.19-0.96 (m, 7H).

¹³C NMR (101 MHz, CDCl₃) δ 154.7, 133.1 (d, J=21.3 Hz), 129.2 (d, J=8.1 Hz), 129.1 (s), 125.9, 116.2 (d, J=27.0 Hz), 109.8, 53.2, 34.4 (d, J=13.3 Hz), 33.4 (d, J=27.8 Hz), 30.7 (d, J=17.9 Hz), 30.1, 29.5 (d, J=8.5 Hz), 27.2 (d, J=10.8 Hz), 27.1 (d, J=6.2 Hz), 26.4, 26.2, 25.5, 21.7.

³¹P NMR (162 MHZ, CDCl₃) δ −18.26.

HRMS (APCI) calc. C₂₇H₄₁N₂OP [M+H]⁺: 441.3024. Found 441.3029.

TLC (10% EtOAc in hexanes): R_{f}=0.29 (UV).

### Example 18. Synthesis of L3 (L3, FIG. 6)

A 10-mL round-bottom flask was charged with 4-bromo-3,6-dimethyl-1-((1S,3S)-3-methylcyclohexyl)-1,3-dihydro-2H-benzo[d]imidazol-2-one 10 (0.5 mmol, 168.6 mg, 1.0 equiv) and 2-MeTHF (8 mL) under a N₂ atmosphere. The mixture was cooled to −78° C. and BuLi (1.0 mmol, 625.0 μL, 2.0 equiv) was added dropwise. The reaction was stirred for 20 minutes and tBu₂PCL (0.525 mmol, 95.0 mg, 1.05 equiv) was added. The reaction was heated to 60° C. for 1 hour and was quenched with saturated NH₄Cl (5 mL). The mixture was extracted with EtOAc (3×10 mL). The combined organic layers were dried over Na₂SO₄ and evaporated under reduced pressure. The crude product was purified by silica column chromatography in 10% EtOAc/hexanes to give L3 (119 mg, 59%, 95:5 d.r.) as a white solid. Analysis results were as follows:

¹H NMR (400 MHZ, CDCl₃) δ 7.22 (s, 1H), 6.93 (s, 1H), 4.27 (tt, J=12.1, 4.1 Hz, 1H), 3.82 (d, J=2.6 Hz, 3H), 2.40 (s, 3H), 2.14 (qd, J=12.8, 3.9 Hz, 1H), 1.95-1.78 (m, 4H), 1.77-1.69 (m, 1H), 1.66-1.58 (m, 1H), 1.46 (qt, J=13.1, 3.6 Hz, 1H), 1.20 (dd, J=12.2, 1.2 Hz, 18H), 1.07-0.99 (m, 1H), 0.97 (d, J=6.5 Hz, 3H).

¹³C NMR (126 MHZ, CDCl₃) δ 154.7, 133.4 (d, J=23.5 Hz), 129.2 (d, J=9.1 Hz), 128.6, 128.2, 118.2 (d, J=33.0 Hz), 109.9, 53.0, 38.4, 34.1 (d, J=6.0 Hz), 33.8, 32.8, 32.8 (d, J=23.1 Hz), 30.8 (dd, J=15.5, 1.3 Hz), 29.3, 25.5, 22.4, 21.6.

³¹P NMR (162 MHZ, CDCl₃) δ 9.88.

HRMS (APCI) calc. C₂₄H₃₉N₂OP [M+H]⁺: 403.2873. Found 403.2869.

IR (Diamond-ATR, neat): \tilde{ν}ₘₐₓ: 650, 675, 750, 1086, 1385, 1449, 1701, 2859, 2926 cm 1

TLC (10% EtOAc in hexanes): R_{f}=0.43 (UV).

### Example 19. Synthesis of (S,S)-L4 (L4, FIG. 7)

A 10-mL round-bottom flask was charged with 4-bromo-1-cyclohexyl-3,6-dimethyl-1,3-dihydro-2H-benzo[d]imidazol-2-one 5 (0.8 mmol, 258.6 mg, 1.0 equiv) and 2-MeTHF (2.5 mL) under a N₂ atmosphere. The mixture was cooled to −78° C. and/BuLi (1.6 mmol, 0.97 mL, 2.0 equiv) was added dropwise. The resulting solution was cannulated into a 10-mL Schlenk flask containing a solution of (2S,5S)-1-chloro-2,5-diphenylphospholane (S,S)-16 in 2-MeTHF (1 mL). The reaction was stirred for 1 hour and allowed to warm to room temperature. The reaction was quenched with saturated aqueous NH₄Cl (10 mL) and extracted with EtOAc (3×10 mL). The combined organic layers were dried over Na₂SO₄ and evaporated under reduced pressure. The crude product was purified by silica column chromatography in 30% EtOAc/hexanes to give (S,S)-L4 as a white solid (179 mg, 46%). Procedure and spectra were identical for (±)-L4, (S,S)-L4, and (R,R)-L4. Analysis results were as follows:

¹H NMR (400 MHZ, CDCl₃) δ 7.39-7.34 (m, 2H), 7.31 (t, J=7.7 Hz, 2H), 7.22-7.16 (m, 1H), 7.04 (s, 1H), 6.96-6.88 (m, 3H), 6.86 (s, 1H), 6.74-6.62 (m, 2H), 4.20-4.02 (m, 2H), 3.84-3.64 (m, 1H), 3.26 (d, J=2.6 Hz, 3H), 2.84-2.69 (m, 1H), 2.44 (s, 3H), 2.41-2.30 (m, 2H), 2.16-2.01 (m, 3H), 1.93-1.81 (m, 2H), 1.71 (d, J=10.9 Hz, 3H), 1.45-1.33 (m, 2H), 1.32-1.18 (m, 1H).

¹³C NMR (101 MHz, CDCl₃) δ 154.0, 144.6 (d, J=20.1 Hz), 138.5 (d, J=2.2 Hz), 132.1 (d, J=20.2 Hz), 129.1, 128.9 (d, J=7.1 Hz), 128.6, 127.9 (d, J=8.8 Hz), 127.4, 127.4 (d, J=3.3 Hz), 126.1 (d, J=2.7 Hz), 125.9 (d, J=1.9 Hz), 124.8 (d, J=2.4 Hz), 116.9 (d, J=40.0 Hz), 109.8, 53.0, 49.3 (d, J=18.5 Hz), 46.5 (d, J=17.2 Hz), 36.4 (d, J=2.0 Hz), 33.6 (d, J=2.9 Hz), 32.4 (d, J=25.9 Hz), 29.9 (d, J=5.5 Hz), 26.0, 25.4, 21.8.

³¹P NMR (162 MHz, CDCl₃) δ 5.60.

HRMS (APCI) calc. C₃₁H₃₅N₂OP [M+H]⁺: 483.2560. Found 483.2556.

IR (Diamond-ATR, neat): \tilde{ν}ₘₐₓ: 696, 750, 833, 1385, 1456, 1697, 2857, 2930, 3022, 3055 cm⁻¹.

TLC (30% EtOAc in hexanes): R_{F}=0.50 (UV).

HPLC(±)-L4 (AD-H column, 95:5 hexanes/IPA, 2.0 mL/min) 3.51 min (46%), 3.82 min (54%).

HPLC (S,S)-L4 (AD-H column, 95:5 hexanes/IPA, 2.0 ml/min) 3.53 min (99%), 3.87 min (1%).

HPLC (R,R)-L4 (AD-H column, 95:5 hexanes/IPA, 2.0 mL/min) 3.58 min (3%), 3.80 min (97%).

### Example 20. Synthesis of (S,S)-L10 (L10, FIG. 6)

### Step 1: Synthesis of (S,S)-L10-BH₃

A 10-mL Schlenk flask was charged with 1-bromonaphthalene 36 (0.5 mmol, 104.0 mg, 1.0 equiv) and 2-MeTHF (2 mL). The flask was cooled to −78° C. and tBuLi (1.0 mmol, 588 μL, 2.0 equiv, 1.70 M) was added dropwise. The resulting solution was cannulated into a 10-mL Schlenk flask containing a solution of (2S,5S)-1-chloro-2,5-diphenylphospholane (S,S)-16 (0.5 mmol, 137 mg, 1.0 equiv) in 2-MeTHF (1 mL). The reaction was stirred for 1 hour and allowed to warm to room temp for 1 hour. The reaction was cooled to 0° C. and borane-dimethylsulfide complex (0.6 mmol, 56.9 μL, 1.2 equiv) was added. The reaction was warmed to room temp, quenched with saturated aqueous NH₄Cl (10 mL), and extracted with EtOAc (3×10 mL). The combined organic layers were dried over Na₂SO₄ and evaporated under reduced pressure. The crude product was purified by silica column chromatography in 15% EtOAc/hexanes to give (S,S)-L10-BH₃ as a white solid (91 mg, 48%). Analysis results were as follows:

³¹P NMR (162 MHZ, CDCl₃) δ 41.45.

TLC (15% EtOAc in hexanes): R_{f}=0.31 (UV).

### Step 2: Synthesis of (S,S)-L10 (L10, FIG. 11)

L10 was prepared according to a modified literature procedure of that reported in Dobrota 2015 (Dobrota, C.; Fiaud, J.-C.; Toffano, M., P-Aryl-Diphenylphospholanes and their Phospholanium Salts as Efficient Monodentate Ligands for Asymmetric Rhodium-Catalyzed Hydrogenation. ChemCatChem 2015, 7, 144-148), incorporated herein by reference. A 10-mL Schlenk flask was charged with (S,S)-L10-BH₃ (68 mg, 0.18 mmol, 1.0 equiv) and DCM (2 mL). The flask was cooled to 0° ° C. and HBF₄·Et₂O (0.72 mmol, 97.0 μL, 4.0 equiv) was added dropwise. The reaction was allowed to warm to room temp and stirred for 1 hour. Saturated aqueous NaHCO₃ (2 mL, freshly sparged with N2) was added with strong stirring. Once the effervescence ceased, the layers were separated via syringe transfer and stored under N₂ in separate 10-mL Schlenk flasks. The aqueous layer was extracted with DCM (2×5 mL) via syringe transfer. The organic layers were combined and filtered through Na₂SO₄ under N₂. The Na₂SO₄ was washed with DCM (10 mL) and the filtrate was concentrated under reduced pressure to yield (S,S)-L10 as a fluffy white solid (58.4 mg, 89%). The product was used without further purification. Spectral data were in accordance with literature reports such as reported in Dobrota 2015 and were as follows:

¹H NMR (400 MHZ, CDCl₃) δ 8.13 (dd, J=9.1, 5.1 Hz, 1H), 7.71 (d, J=8.2 Hz, 1H), 7.68 (dd, J=7.2, 2.8 Hz, 1H), 7.63 (d, J=8.1 Hz, 1H), 7.46-7.37 (m, 3H), 7.33 (t, J=7.7 Hz, 2H), 7.29-7.24 (m, 1H), 7.24-7.18 (m, 1H), 7.13-7.07 (m, 1H), 6.81-6.70 (m, 5H), 4.20-4.10 (m, 1H), 4.03-3.89 (m, 1H), 2.89-2.71 (m, 1H), 2.55-2.32 (m, 2H), 2.25-2.10 (m, 1H).

³¹P NMR (162 MHZ, CDCl₃) δ 7.46.

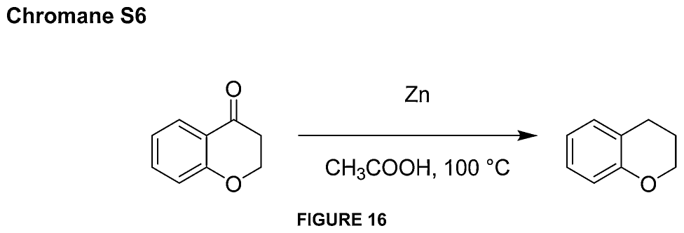

### Example 21. Synthesis of Chromane S6 (S6, FIG. 16)

S6 was prepared according to a literature procedure reported in McManus 2017 (McManus, J. B.; Nicewicz, D. A., Direct C-H Cyanation of Arenes via Organic Photoredox Catalysis. J. Am. Chem. Soc. 2017, 139, 2880-2883) which is herein incorporated by reference. Analysis results were as follows:

¹H NMR (400 MHZ, CDCl₃): δ 7.13-7.00 (m, 1H), 6.82 (dddd, J=16.4, 8.3, 3.7, 1.4 Hz, 1H), 4.23-4.15 (m, 1H), 2.80 (td, J=6.6, 2.1 Hz, 1H), 2.07-1.96 (m, 1H).

¹³C NMR (101 MHz, CDCl₃) δ 155.1, 130.0, 127.3, 122.4, 120.2, 116.8, 66.6, 25.0, 22.5.

TLC (10% EtOAc in hexanes): R_{f}=0.90 (UV).

### Example 22. Synthesis of sec-butylzinc Bromide 20 (20, FIG. 9)

A 50-mL Schlenk flask was charged with acid-washed zinc metal (60 mmol, 3.92 g, 4.0 equiv, washed successively with dilute HCl, water, acetone, and Et₂O, dried under reduced pressure, and stored in an argon-filled glovebox). The flask was heated to ˜150° C. with a heat gun for 10 minutes under reduced pressure (0.1 torr) and allowed to cool to room temp. 2-MeTHF (15 mL) and 1,2-dibromoethane (0.75 mmol, 65.0 μL, 5.0 mol %) were added. The mixture was heated to 60° C. in an oil bath for 10 minutes. The flask was removed from the bath and allowed to cool, and TMSCl (0.15 mmol, 19.0 μL, 1.0 mol %) was added. The flask was heated again to 60° C. for 10 minutes, removed from the bath, and allowed to cool. 2-bromobutane (15.0 mmol, 1.64 mL, 1.0 equiv) was added and the mixture was heated to reflux with strong stirring for 16 hours. The mixture was cooled to room temp and filtered through a syringe filter. The resulting solution was titrated using Knochel's procedure (see Krasovskiy, A.; Knochel, P., Convenient Titration Method for Organometallic Zinc, Magnesium, and Lanthanide-Reagents. Synthesis 2006, 2006, 0890-0891; “Krasovskiy 2006,” which is herein incorporated by reference).

### Example 23. Synthesis of chroman-4-ylzinc Chloride 34 (34, FIG. 9)

A 25-mL pear-shaped flask was charged with chromane (3.0 mmol, 380.0 μL, 1.0 equiv), HMPA (6.0 mmol, 1.04 mL, 2.0 equiv), and THF (3 mL). The flask was cooled to −78° C. and/BuLi (3.0 mmol, 1.82 mL, 1.0 equiv, 1.65 M) was added dropwise, resulting in a deep red color. The resulting solution was transferred via cannula to a 10-mL Schlenk flask containing anhydrous ZnCl₂ (3.0 mmol, 409 mg, 1.0 equiv, purified by fusing under hi-vac) cooled to −78° C. The solution was stirred at −78° C. for 30 minutes and warmed to room temp. The resulting solution was titrated using Knochel's procedure (see Krasovskiy 2006, which is herein incorporated by reference).

### Example 24. Synthesis of 4-fluoro-4′-methoxy-1,1′-biphenyl 19 (19, FIG. 8, Reaction 1)

An oven-dried dram vial was charged with Pd₂dba₃ (4 μmol, 3.7 mg, 0.02 equiv), L1 (8 μmol, 3.1 mg, 0.04 equiv), and (4-methoxyphenyl)boroxine 17 (0.08 mmol, 32.1 mg, 0.4 equiv). The vial was purged with N₂ and 1,4-dioxane (600 μL), sparged water (200 μL), K₂CO₃ (5M solution in sparged water, 100 μL), and 1-bromo-4-fluorobenzene 18 (0.2 mmol, 35.0 mg, 1.0 equiv) were added. The reaction was stirred at 80° C. for 4 hours and trifluorotoluene (0.067 mmol, 9.8 mg) was added as an internal standard. The neat reaction mixture was analyzed by ¹⁹F NMR. The yield was determined to be 85% by integration of the 19F NMR product peak (-118.5 ppm) vs. the trifluorotoluene internal standard (-63.7 ppm). Spectral data were in accordance with literature such as reported in Denmark 2009 and were as follows:

¹⁹F NMR (470 MHz, CDCl₃) δ −118.5.

### Example 25. sec-butylbenzene 22 (22, FIG. 8, Reaction 2)

An oven-dried dram vial was charged with Pd₂dba₃ (4 μmol, 3.7 mg, 0.02 equiv), L1 (8.0 μmol, 3.1 mg, 0.04 equiv), and optionally an additive (LiCl or none) (0.4 mmol, 2.0 equiv). The vial was purged with N₂ and 2-MeTHF (0.5 mL) was added. The mixture was stirred for 30 minutes at room temperature and bromobenzene 21 (0.2 mmol, 31.4 mg, 1.0 equiv) was added. The reaction was cooled to 0° C. and sec-butylzinc bromide 20 (0.59 M in 2-MeTHF, 0.3 mmol, 500.0 μL, 1.5 equiv) was added dropwise. The reaction was sealed with a fresh septa-cap and heated to 60° C. for 24 hours, at which point a 40 μL aliquot was removed and quenched with saturated NH₄Cl. 1,3,5-trimethoxybenzene (0.3 M in EtOAc, 15 μmol, 50 μL,) was added to the quenched aliquot, which was subsequently extracted with EtOAc and analyzed by GC-FID. Yields were calculated by calibrated GC-FID integration vs. the trimethoxybenzene internal standard.

### Example 26. Synthesis of (2-methylbutyl)benzene 24 (24, FIG. 8, Reaction 3)

An oven-dried dram vial was taken into the glovebox and charged with Ni(COD)₂ (8 μmol, 2.2 mg, 0.04 equiv). The vial was sealed with a septa-cap and moved to the fume hood where L1 (8.0 μmol, 3.1 mg, 0.04 equiv) was added as a solution in 2-MeTHF (400 μL). The mixture was cooled to 0° C. and benzyl bromide 23 (0.2 mmol, 34.2 mg, 1.0 equiv) was added, followed by dropwise addition of sec-butylzinc bromide 20 (0.52 M in 2-MeTHF, 0.3 mmol, 577.0 μL, 1.5 equiv). The reaction was stirred at room temperature for 48 hours, at which point the reaction was quenched with saturated NH₄Cl (0.5 mL). Trimethoxybenzene (0.4 M in EtOAc, 0.02 mmol, 50.0 μL,) and EtOAc (1 mL) were added to the quenched reaction. The layers were separated and the aqueous phase was extracted with EtOAc (2×2 mL). The combined organic layers were dried over Na₂SO₄ and evaporated under reduced pressure. The crude product was analyzed by 1H NMR. Yields were calculated by ¹H NMR peak integration of the product benzylic CH signals at 2.63 ppm (dd, J=13.4, 6.2 Hz, ¹H) and 2.35 ppm (dd, J=13.4, 8.1 Hz, ‘H) vs. the trimethoxybenzene internal standard (6.09 and 3.77 ppm). Branched:linear ratio was determined by relative GC-FID peak integrations. Product analysis: 42% yield, >95:5 branched:linear.

### Example 27. 4-[1,1′-Biphenyl]-4-ylmorpholine 27 (27, FIG. 8, Reaction 4)

A dram vial was charged with 4-bromobiphenyl 26 (0.2 mmol, 46.6 mg, 1.0 equiv), NaOtBu (0.28 mmol, 26.9 mg, 1.4 equiv), Pd₂dba₃ (0.004 mmol, 3.7 mg, 2.0 mol %), and L1 (0.008 mmol, 3.1 mg, 4.0 mol %). The vial was purged with N₂ and toluene (0.5 mL) was added followed by morpholine 25 (21 μL, 0.24 mmol, 1.2 equiv). The vial was sealed with an unpunctured septa-cap and the reaction was heated to 110° C. for 16 hours. The reaction was quenched by the addition of water (1 mL) and 1,3,5-trimethoxybenzene (33.6 mg, 0.2 mmol, 1.0 equiv) was added. The aqueous layer was extracted with EtOAc (3×3 mL). The combined organic extracts were dried over Na₂SO₄, filtered and the filtrate was concentrated in vacuo. The crude product was analyzed by ¹H NMR. Spectral data were in accordance with literature reports such as reported in Ackermann 2005. Integration of the morpholine CH₂ signals (3.89 and 3.21 ppm) vs. the CH₃ and CH of the standard (6.09 and 3.77 ppm) determined the product yield to be 73%.

### Example 28. Palladium-Catalyzed C—O Cross-Coupling Reaction Test (FIG. 8, Reaction 5)

A dram vial was charged with 4-bromobiphenyl 26 (0.2 mmol, 46.6 mg, 1.0 equiv), NaOtBu (0.24 mmol, 23.0 mg, 1.2 equiv), Pd₂dba₃ (0.004 mmol, 3.7 mg, 2.0 mol %), and L1 (0.008 mmol, 3.1 mg, 4.0 mol %). The vial was purged with N₂ and THF (0.5 mL) was added followed by 1-octanol 28 (0.4 mmol, 63.0 μL, 2.0 equiv). The vial was scaled with an unpunctured septa-cap and the reaction was heated to 60° C. for 16 hours. The reaction was quenched by the addition of water (1 mL). The aqueous layer was extracted with EtOAc (3×3 mL). The combined organic extracts were dried over Na₂SO₄, filtered and the filtrate was concentrated in vacuo. The crude product was analyzed by ¹H NMR and GC-MS. The desired product 4-(Octyloxy)-1,1′-biphenyl was not detected by either method. The halide 26 was fully consumed and the major product was reduction of the halide to give biphenyl 30.

### Example 29. Synthesis of (±)-4-(sec-butyl)-1,1′-biphenyl (±)-31 (31, FIG. 9, Reaction 6)

A solution of [1,1′-biphenyl]-4-ylmagnesium bromide S8 (11.0 mmol, 11.0 mL, 1.0 equiv, 1.0 M in THF) was prepared by insertion of magnesium metal into 4-bromobiphenyl 26. A 100-mL round bottom flask was charged with CuCN (0.73 mmol, 65.4 mg, 0.066 equiv) and THF (8 mL). The flask was cooled to −78° C. and the solution of S8 was added slowly, followed by the addition of neat 2-bromobutane S7 (22.6 mmol, 3.10 g, 2.0 equiv). The mixture was allowed to warm to room temperature and was heated overnight to reflux. The reaction was quenched with sat. NH₄Cl (10 mL) and extracted with EtOAc (3×10 mL). The combined organic extracts were dried over Na₂SO₄, filtered and the filtrate was concentrated in vacuo. The crude product was purified by silica column chromatography in 100% hexanes followed by purification by prep-HPLC on a C18 column in 1% MeOH/MeCN to give (±)-31 as a clear oil (1.96 g, 85%). Spectral data were in accordance with literature reports such as reported in Zhao 2018 and were as follows:

¹H NMR (400 MHZ, CDCl₃) δ 7.70 (d, J=7.2 Hz, 1H), 7.64 (d, J=7.5 Hz, 1H), 7.57-7.46 (m, 1H), 7.45-7.39 (m, OH), 7.36 (d, J=8.3 Hz, 1H), 2.75 (h, J=7.0 Hz, 1H), 1.75 (p, J=7.6 Hz, 1H), 0.98 (t, J=7.5 Hz, 1H).

TLC (hexanes): R_{f}=0.61 (UV).

HPLC (OD-H column, hexanes, 1.0 ml/min) 12.15 min (50%), 19.96 min (50%).

### Example 30. Synthesis of 4-(sec-butyl)-1,1′-biphenyl 31 (31, FIG. 9, Reaction 6)

An oven-dried dram vial was charged with Pd₂dba₃ (4.0 μmol, 3.7 mg, 0.02 equiv) and L3 (8 μmol, 3.2 mg, 0.04 equiv). The vial was purged with N₂ and 2-MeTHF (0.5 mL) was added. The mixture was stirred for 30 minutes at room temperature and 4-bromobiphenyl 26 (0.2 mmol, 31.4 mg, 1.0 equiv) was added. The reaction was cooled to 0° C. and sec-butylzinc bromide 20 (0.3 mmol, 1.5 equiv) was added dropwise. The reaction was sealed with a fresh septa-cap and heated to 60° C. for 16 hours. The reaction was quenched by the addition of saturated NH₄Cl (1 mL) and a solution of 1,3,5-trimethoxybenzene (0.02 mmol, 50.0 μL, 0.4 M in EtOAc) was added. The aqueous layer was extracted with EtOAc (3×3 mL). The combined organic extracts were dried over Na₂SO₄, filtered and the filtrate was concentrated in vacuo. Yields were determined by GC-FID integration vs. the internal standard. Result with L3 was as follows:

HPLC (OD-H, hexanes, 1.0 mL/min) 12.57 min (51%), 20.98 min (49%).

The same reaction was performed on a 0.1 mmol scale of 26 using (S,S)-L4 (4 μmol, 1.9 mg, 0.04 equiv) instead of L3. Result with (S,S)-L4 was as follows:

HPLC (OD-H, hexanes, 2.0 mL/min) 6.14 min (50%), 10.11 min (50%).

### Example 31. Synthesis of (±)-2-(2-methylbutyl)naphthalene (±)-33 (33, FIG. 9, Reaction 7)

A 50-mL Schlenk flask was charged with CuI (2.5 mmol, 476 mg, 1.0 equiv) and Et₂O (12.5 mL). The reaction was cooled to −78° C. and s-BuLi (5.0 mmol, 3.57 mL, 2.0 equiv, 1.4 M) was added dropwise. The reaction was stirred for 30 minutes and 2-(bromomethyl)naphthalene 32 was added as a solid in one portion. The reaction was allowed to warm to room temperature over 48 hours and was quenched with saturated NH₄Cl (20 mL). The layers were separated and the aqueous layer was extracted with EtOAc (2×15 mL). The combined organic layers were dried over Na₂SO₄, filtered, and concentrated in vacuo. The crude product was purified by silica column chromatography in 2% EtOAC/hexanes to give the desired product 33 (300 mg, 61%). An analytical sample was purified by reverse-phase prep-HPLC in 1% MeOH/MeCN. Analysis results were as follows:

¹H NMR (400 MHZ, CDCl₃) δ 7.87-7.74 (m, 3H), 7.61 (s, 1H), 7.51-7.41 (m, 2H), 7.34 (dd, J=8.4, 1.2 Hz, 1H), 2.83 (dd, J=13.4, 6.2 Hz, 1H), 2.56 (dd, J=13.4, 8.1 Hz, 1H), 1.86-1.72 (m, J=6.6 Hz, 1H), 1.54-1.41 (m, 1H), 1.32-1.19 (m, 1H), 0.97 (t, J=7.4 Hz, 3H), 0.92 (d, J=6.8 Hz, 3H).

¹³C NMR (101 MHZ, CDCl₃) δ 139.4, 133.7, 132.1, 128.1, 127.7, 127.7, 127.5, 127.4, 125.9, 125.1, 43.7, 36.8, 29.4, 19.2, 11.7.

HRMS (APCI) calc. C₁₅H₁₈ [M+H]⁺: 199.1481. Found 199.1482.

IR (Diamond-ATR, neat): \tilde{ν}ₘₐₓ: 745, 808, 854, 1375, 1456, 1506, 2872, 2922, 2957, 3051 cm⁻¹.

TLC (2% EtOAc in hexanes): R_{f}=0.68 (UV).

HPLC (OD-H column, hexanes, 2.0 ml/min) 8.21 min (50%), 10.00 min (50%).

### Example 32. Synthesis of 2-(2-methylbutyl)naphthalene 33 (33, FIG. 9, Reaction 7)

An oven-dried dram vial was taken into the glovebox and charged with Ni(COD)₂ (8.0 μmol, 2.2 mg, 0.04 equiv). The vial was sealed with a septa-cap and moved to the fume hood where L1 (8.0 μmol, 3.1 mg, 0.04 equiv) was added as a solution in 2-MeTHF (400 μL). The mixture was cooled to 0° ° C. and 2-(bromomethyl)naphthalene 32 (0.2 mmol, 44.2 mg, 1.0 equiv) was added, followed by dropwise addition of sec-butylzinc bromide 20 (0.3 mmol, 508.0 μL, 1.5 equiv, 0.59 M in 2-MeTHF). The reaction was stirred at room temperature for 48 hours, at which point the reaction was quenched with saturated NH₄Cl (0.5 mL). Trimethoxybenzene (0.02 mmol, 50.0 μL, 0.4 M in EtOAc) and EtOAc (1 mL) were added to the quenched reaction. The layers were separated and the aqueous phase was extracted with EtOAc (2×2 mL). The combined organic layers were dried over Na₂SO₄ and evaporated under reduced pressure. The crude product was analyzed by 1H NMR. Yields were calculated by integration of the product diastereotopic benzylic CH signals vs. the trimethoxybenzene internal standard. Result was as follows:

HPLC (OD-H column, hexanes, 2.0 ml/min) 8.64 min (51%), 10.54 min (49%).

### Example 33. Synthesis of (±)-4-([1,1′-biphenyl]-4-yl)chromane (±)-35 (35, FIG. 9, Reaction 8)

A dram vial was charged with Pd(OAc)₂ (8 μmol, 1.8 mg, 0.04 equiv), L1 (8 μmol, 3.1 mg, 0.04 equiv), and 4-bromobiphenyl 26 (0.2 mmol, 46.6 mg, 1.0 equiv). The vial was purged with N₂ and THF (200 μL) was added. The mixture was cooled to 0° C. and stirred for 30 minutes followed by dropwise addition of the zinc reagent (0.3 mmol, 1.0 mL, 1.5 equiv, 0.29 M). The reaction was allowed to warm to room temperature over 16 hours and was quenched with saturated NH₄Cl (1 mL). EtOAc (1 mL) was added and the layers were separated. The aqueous layer was extracted with EtOAc (2×2 mL) and the combined organic layers were dried over Na₂SO₄, filtered, and concentrated in vacuo. The crude product was purified by prep-TLC in 1% EtOAC/hexanes to give the desired product 33 (24 mg, 42%). Results were as follows:

¹H NMR (400 MHZ, CDCl₃) δ 7.65-7.59 (m, 2H), 7.57 (d, J=8.4 Hz, 2H), 7.46 (t, J=7.6 Hz, 2H), 7.36 (t, J=7.4 Hz, 1H), 7.24 (d, J=8.1 Hz, 2H), 7.22-7.15 (m, 1H), 6.93 (d, J=8.3 Hz, 2H), 6.89-6.82 (m, 1H), 4.33-4.18 (m, 3H), 2.46-2.30 (m, 1H), 2.25-2.09 (m, 1H).

¹³C NMR (101 MHz, CDCl₃) δ 155.3, 144.9, 140.9, 139.5, 130.8, 129.2, 128.9, 128.0, 127.3, 127.3, 127.2, 124.6, 120.5, 117.0, 64.0, 40.8, 31.8.

HRMS (APCI) calc. C₂₁H₁₈O [M+H]⁺: 287.1430. Found 287.1429.

IR (Diamond-ATR, neat): \tilde{ν}ₘₐₓ: 704, 739, 752, 773, 833, 1059, 1221, 1248, 1450, 1483, 2859, 2913, 2943, 2978, 3028 cm⁻¹.

TLC (5% EtOAc in hexanes): R_{f}=0.43 (UV).

HPLC (AD-H column, 99:1 hexanes/IPA, 2.0 mL/min) 3.54 min (50%), 4.57 min (50%).

### Example 34. Synthesis of 4-([1,1′-biphenyl]-4-yl)chromane 35 (35, FIG. 9, Reaction 8)

An oven-dried dram vial was charged with Pd₂dba₃ (4.0 μmol, 3.7 mg, 0.02 equiv) and (S,S)-L4 (8.0 μmol, 3.9 mg, 0.04 equiv). The vial was purged with N₂ and THF (250 μL) was added. The mixture was stirred for 30 minutes at room temperature and 4-bromobiphenyl (0.2 mmol, 46.6 mg, 1.0 equiv) was added as a solution in THF (250 μL), followed by dropwise addition of the zinc reagent (0.3 mmol, 1.0 mL, 1.5 equiv). The reaction was stirred at 80° C. for 16 hours, at which point the reaction was quenched with saturated NH₄Cl (0.5 mL). EtOAc (1 mL) was added and the mixture was filtered through celite. The layers were separated and the aqueous phase was extracted with EtOAc (2×2 mL). The combined organic layers were dried over Na₂SO₄ and evaporated under reduced pressure. The product was purified by silica column chromatography in 2% EtOAc/hexanes to give the title compound (48 mg, 84%) as a white solid. Results were as follows:

HPLC (AD-H column, 99:1 hexanes/IPA, 2.0 mL/min) 3.61 min (65%), 4.60 min (35%).

### Example 35. Procedure for Reaction 9 (FIG. 10)

An oven-dried dram vial was charged with Pd₂dba₃ (2.0 μmol, 1.8 mg, 0.02 equiv) and ligand (4.0 μmol, 0.04 equiv) (tested ligands set forth in Table 1). The vial was purged with N₂ and THF (250 μL) was added. The mixture was stirred for 30 minutes at room temperature and 4-bromobiphenyl (0.1 mmol, 23.3 mg, 1.0 equiv) was added as a solution in THF (250 μL), followed by dropwise addition of the zinc reagent (0.15 mmol, 1.5 equiv). The reaction was stirred at room temp for 16 hours, at which point the reaction was quenched with saturated NH₄Cl (0.5 mL). 1,3,5-trimethoxybenzene (0.01 mmol, 50.0 μL, 0.1 equiv, 0.2 M in EtOAc,) and EtOAc (1 mL) were added and the mixture was filtered through celite. The layers were separated and the aqueous phase was extracted with EtOAc (2×2 mL). The combined organic layers were dried over Na₂SO₄ and evaporated under reduced pressure. Yields were determined by 1H NMR integration of the product benzylic CH (2.29-2.40 ppm) vs. the internal standard (6.09 and 3.77 ppm). c.r. was determined by HPLC analysis.

### Example 36. Procedure for Reaction 10 (FIG. 11)

A dram vial was charged with (R,R)-L4 or (S,S)-L10 (4.0 mol % or 8.0 mol %), Pd₂dba₃ (4.0 μmol, 3.7 mg, 2.0 mol %), and THF (0.25 mL). 4-bromobiphenyl 26 (0.2 mmol, 46.6 mg, 1.0 equiv) was added as a solution in THF followed by dropwise addition of the zinc reagent 34 (0.15 mmol, 1.5 equiv). The reactions were stirred at room temperature for 20 hours at which time GC analysis showed no formation of product 35. The reactions were then heated to 60° C. for 24 hours and quenched with saturated NH₄Cl (0.5 mL). 1,3,5-trimethoxybenzene (0.1 mmol, 50 μL, 1.0 equiv, 2.0 M in EtOAc) and EtOAc (1 mL) were added and the mixture was filtered through celite. The layers were separated and the aqueous phase was extracted with EtOAc (2×2 mL). The combined organic layers were dried over Na₂SO₄ and evaporated under reduced pressure. Yields were determined by 1H NMR integration of the product benzylic CH (2.29-2.40 ppm) vs. the internal standard (6.09 and 3.77 ppm). e.r. was determined by HPLC analysis.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A compound represented by formula (I):

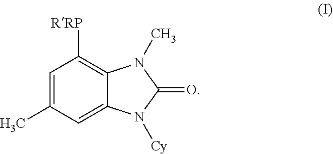

2. A compound represented by formula (L1):

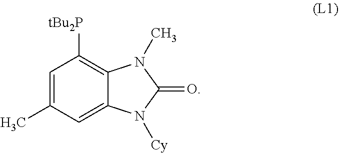

3. The compound of claim 2, wherein the compound is synthesized using trimethylsilyl trifluoromethanesulfonate.

4. The compound of claim 2, wherein the compound is synthesized using 2-methyltetrahydrofuran.

5. A compound represented by formula (L2):

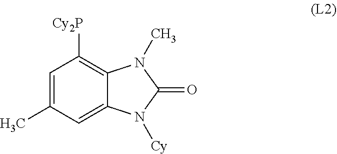

6. The compound of claim 5, wherein the compound is synthesized using trimethylsilyl trifluoromethanesulfonate.

7. The compound of claim 5, wherein the compound is synthesized using 2-methyltetrahydrofuran.

8. A compound represented by formula (L3):

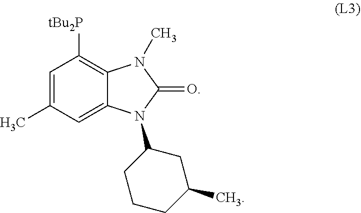

9. The compound of claim 8, wherein the compound has a diastereometric ratio of 95:5.

8. The compound of claim 8, wherein an intermediate compound is represented by formula (L3a):

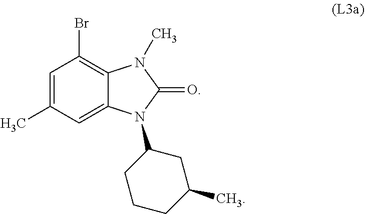

11. A compound represented by formula (L4):

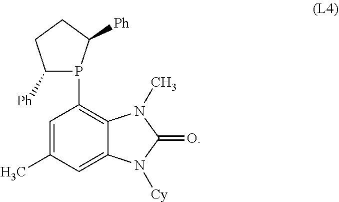

12. The compound of claim 11, wherein the compound has an enantiomeric ratio of 99:1.

13. The compound of claim 11, wherein the compound is capable of catalyzing an enantioselective cross-coupling reaction.

14. The compound of claim 11, wherein the enantioselective cross-coupling reaction yields a cross-coupling product having an enantiomeric ratio of 33:67.

15. compound represented by formula (G): 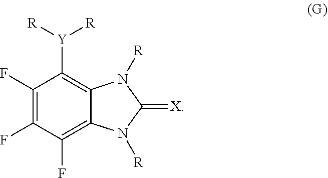
wherein
Y is P;
X is O; and
R represents independently for each occurrence hydrogen, alkyl, aryl, or cycloalkyl.

16. The compound of claim 15, wherein at least one R is a cycloalkyl group.

17. The compound of claim 15, wherein at least one R is an alkyl group.

18. The compound of claim 15, wherein at least one R is an aryl group.

19. The compound of claim 15, wherein each R group is H.

20. The compound of claim 15, wherein the compound is capable of catalyzing an enantioselective cross-coupling reaction.
